(19) United States
(12) Patent Application Publication
(10) Pub. No.: US 2014/0166447 A1
(43) Pub. Date: Jun. 19, 2014

(54) METHOD AND APPARATUS FOR CONTROLLING OPERATIONS AND SIGNALING AT TIMES DEPENDENT ON CLOCK, CALENDAR AND GEOGRAPHIC LOCATION

(71) Applicant: United Electrical Systems, LLC, Clifton, NJ (US)

(72) Inventors: William Thea, Upper Saddle River, NJ (US); Joel Thea, New York, NJ (US); Yonason Bloch, Lakewood, NJ (US); Maximilian Linder, Phillipsburg, NJ (US); Dario Bianco, Basking Ridge, NJ (US)

(73) Assignee: United Electrical Systems, LLC, Clifton, NJ (US)

(21) Appl. No.: 14/015,024

(22) Filed: Aug. 30, 2013

Related U.S. Application Data
(63) Continuation-in-part of application No. 13/409,774, filed on Mar. 1, 2012.
(60) Provisional application No. 61/696,193, filed on Sep. 2, 2012.

(51) Int. Cl. H01H 43/02

(52) U.S. Cl. CPC H01H 43/02
USPC 200/19.01

(57) ABSTRACT

Techniques are provided for inhibiting changes in the operational state of electrical circuits for lights, appliances and other devices by controlling the effect of manual actuation of an electrical switch in an electrical circuit. A normal mode is established in which manual actuation of the switch effects a change in a state of current flow in the circuit. An alternative holiday mode is also established in which manual actuation of the switch has no effect on current flow in the circuit. Automatic switching occurs between the normal mode and the holiday mode at specific times corresponding to specific events dependent on the time of year, a time of day and a geographic location of the circuit.

### CROSS REFERENCE TO RELATED APPLICATIONS

This application claims priority to U.S. Provisional Patent Application Ser. No. 61/696,193 filed on Sep. 2, 2013, the entirety of which is incorporated herein by reference. This application is also a continuation-in-part of, and pertains to improvements and/or supplements to the subject matter disclosed in, U.S. patent application Ser. No. 13/409,774, filed Mar. 1, 2012 and titled “Method And Apparatus For A Geographically Determined Jewish Religious Clock And Electrical Device Combination With Holiday And Preference Modes,” which application claims the benefit of the filing date of U.S. Provisional Patent Application No. 61/449,031, filed on Mar. 3, 2011. The entire disclosures in these applications are incorporated herein by reference.

### FIELD OF THE INVENTION

The present invention pertains generally to inhibiting changes in the operational state of appliances and other devices (e.g., electronic or other devices). Additionally, the present invention involves providing alarms and/or other signals, in response to recurring events. For example, the techniques described herein are useful during events occurring on dates that are not necessarily the same from year to year and that may, in some examples, vary in their occurrence on the Gregorian calendar. For example, at times these events may change from day to day as a function of time of year, and the occurrence of the events may be dependent on geographic location.

More specifically, in one aspect the present invention pertains to methods and apparatus for automatically controlling the operation of appliances and devices such that their operational state cannot be changed in violation of Jewish law on Sabbath, holidays, and festivals. In addition, the present invention pertains to providing audible or visible alarms or signals to indicate times for regularly occurring (e.g., daily) ritual observance required under Jewish law where those times change from day to day as a function of time of year and geographic location.

### BACKGROUND OF THE INVENTION

Jewish people are commanded to refrain from thirty-nine categories of labor on the Sabbath, holy days and festivals. For simplicity, these days are referred to collectively herein as “Jewish Holidays.” The timing of the Jewish Holidays and the rules governing the interplay between them may be found in the Jewish Law, or Halakhah. The Halakhah includes the Tanakh (i.e., Torah, Nevi'im, and Ktuvim) and Talmudic Literature (which includes the Misluiah, Tosefta, Jerusalem Talmud and Babylonian Talmud), each of which is herein incorporated by reference. Among the acts prohibited by Jewish Law on the Jewish Holidays are changing the operational state of electric lights. For example, it is a prohibited act, under Jewish Law in the category of lighting and extinguishing a fire, to actuate manually operable electric switches that function to turn on or off such lights. Similarly, it is prohibited to change the state of current flow through an electrical appliance during Sabbath and other specified times during Jewish Holidays. Therefore, when observing Jewish Law it is necessary to take extreme care to not change accidentally the operational state of a light or appliance by inadvertently actuating the controlling switch. In addition, there is a concern where small children or non-Jewish people may accidentally or inadvertently change the desired state of the light or appliance during a holiday, unaware that a Jewish person is not permitted to return the light to its previous operational state or even request another person to do so. Thus, Jewish people go to great lengths in order to prevent or at least mitigate these concerns by painstakingly applying tape to numerous light switches just prior to a Jewish Holiday so as to prevent their actuation.

An alternative solution to taping switches is to mount a cover on the switch, an example being presented in U.S. Pat. No. 4,506,120 (Fleischman) which discloses a cover plate that can be mounted on a wall or wall switch plate prior to the Jewish Holiday, and removed after the Jewish Holiday, to physically block manual access to the switch. While this cover plate approach can avoid unintended switch actuation, the mounting and removal activities may themselves be in violation of Jewish law if done during times of the proscribed activities. Furthermore, at the very least the act of mounting is inconvenient, and individuals often forget to mount the plate in a timely manner. Thus, the cover plates may be inadequately or incompletely installed during the Jewish Holiday, which increases the risk for an accidental violation of the Jewish Law during the proscribed period. Additionally, since securing the state of lights is usually one of the last tasks completed just moments before the start of Jewish Holiday, these time-consuming actions cause personal stress as the individual searches for tape or switch covers and rushes to secure the light switch from manipulation during the holiday.

The proscription against changing the state of the lights results in enormous amounts of electrical energy and money being wasted by leaving lights activated throughout the entire day and night. Sometimes the weekly Sabbath and other Jewish Holidays occur in conjunction with each other, leaving numerous lights on for up to three days.

It is therefore desirable to provide means for automatically preventing operational state changes for electric lights in response manual operation of switches during the time periods proscribed under Jewish law.

As stated above, in addition to electric lights, inadvertent manually induced operational state changes of other appliances and devices on the Jewish Holidays present serious concerns. For example, it is in violation of Jewish Law to manually change the operational state of refrigerators, coffee makers and other water heating pots, dishwashers, television sets, radios, ovens (microwave, electric or gas), fans, air conditioners, furnaces, hot water valves, electric locks, etc. Therefore, it is desirable to automatically inhibit manually induced state changes of appliances and devices during the times specified by Jewish Law.

Automatically inhibiting changing the state of lights, appliances and other devices to accommodate Jewish law is not simply a matter of performing some control function at the same time each day because the times of relevant daily events (e.g., sunrise, sundown, etc.) are dependent, not only on the time of day but also on the calendar (i.e., time of year, time of month, etc.) and on geographic location. Moreover, the dates of Jewish Holidays and festivals are determined by the lunar calendar and do not fall on the same dates of the Gregorian calendar from year to year. Thus, in seeking to automatically prevent manual switch actuation from changing the operational states of lights, appliances and devices to accommodate Jewish law, it is necessary to consider both clock and calendar-dependent variations in times and dates as well as different geographic locations.

Certain prayers, services and other observances in Jewish law must be performed by individuals at specific times during the day. These events, too, are dependent on the time of day, time of year and the geographic location of the individual, so that it is not simply a matter of setting an alarm on a standard watch, clock or clock-radio to remind an individual of the observance activity to be performed. It is desirable, therefore, to provide a suitable means for automatically reminding individuals at the appropriate times of the observance activities to be performed.

### SUMMARY OF THE INVENTION

It should be appreciated that the techniques described herein are only a partial description of the invention. The summary provided herein is for convenience and is not to be construed as affecting the scope of the present invention.

In one aspect of the invention, the techniques (e.g., apparatus and methods) described herein function to utilize date, time and geographic location data and combine them with electronic and/or mechanical devices to enable a control system to operate apparatus in accordance with Jewish Law. In particular, the techniques described herein utilize religious reference times that are calculated from the positional relationship of the sun and moon to a specific geographic location to control operations of one or more devices (e.g., electronic and/or mechanical appliances or devices).

In a broad sense the invention pertains to preventing manual actuation of an on/off switch connected in an electrical circuit from affecting current flow in the circuit in response to at least one of two or more operating modes. That operating mode, referred to herein for convenience as a holiday mode, may be initiated manually (e.g., by manually actuating another switch) or, more preferably, automatically by an electronic timer system. In the preferred embodiment the timer system accesses data comprising information of Jewish Holidays (e.g., from a database of information stored about a Jewish calendar) to determine Gregorian calendar dates and times of specified Jewish events (e.g., Sabbath, holidays, prayer time, etc.). The data may be stored in the timer system or retrieved from a remote location. For example, the timer system may access the data from a remote database via, e.g., an Internet connection or other network connectivity techniques now known or heretofore contemplated. The timer system similarly accesses data representing the time of year, time of day and the geographic location of the electrical circuit (internally stored or remotely retrieved). From this data the system establishes a plurality of operating modes for a device. For example, the system establishes a normal operating mode in which the on/off switch is permitted to effect current changes in the circuit. The system also establishes a holiday operating mode in which the state of circuit current flow existing at the time of holiday mode initiation is maintained irrespective of manual actuation of the on/off switch (i.e., such that during the holiday mode, a user of the device cannot effect current changes in the circuit.)

In another aspect of the invention, methods and apparatus are provided for automatically controlling the effect of manual actuation of an electric switch on an electrical circuit at specified times by establishing a normal mode in which manual actuation of the switch effects a change in the state of current flow in the circuit, establishing a holiday mode as an alternative to the normal mode and in which manual actuation of the switch has no effect on current flow in the circuit, automatically switching from the normal mode to the holiday mode at the specified times corresponding to specified events dependent on the time of year, the time of day and the geographic location of the circuit, and automatically switching back from the holiday mode to the normal mode after predetermined times in the holiday mode corresponding to the durations of the events, which durations are dependent on the time of year, the time of day and the geographic location of the circuit for each event. The electrical circuit may be electrical lights or any electrical appliance.

In still another aspect of the invention an electrical switch assembly is part of a control system and is mounted in place of a conventional light switch and provides a means of selecting between a normal mode and a holiday mode. If the holiday mode is activated, the control system overrides normal mode functionality. At the onset of the holiday period the control system fixes the state of current flow to the lights at the then existing state, maintaining that state regardless of the user's physical manipulation of the light switch. In another aspect, the ability to select modes is provided by means of a button to activate the control system for automatically initiating the holiday mode at the beginning of a Jewish Holiday and for automatically deactivating the holiday mode at the end of a Jewish Holiday. In still another aspect the same principles are applied to an on/off switch for any electrical circuit (e.g., in an appliance) to prevent changes in current flow in the circuit irrespective of manual switch actuation while the system is in the holiday mode.

In a further aspect, techniques may be employed to store in the control system data representing a holiday calendar and to detect or compute local date, time, and daylight conditions within the apparatus, to facilitate the above functions.

In another aspect of the invention an electronic timer system is configured so that at selected times it automatically prevents manual actuation of an electrical switch from changing the state of current flow in a circuit in which the switch is connected. The switch may be in a circuit with electric lights or appliances. In a preferred embodiment the selected times correspond to those established under Jewish Law during which manual actuation and de-actuation of lights, appliances, etc., are prohibited. The same timer may alternatively or additionally provide visible and/or audible signals or alarm at times for prayer and other ritual observances that are required each day under Jewish Law. The data for determining the various event dates and times may be stored in the timer system along with data representing the geographic location of the system. Geographic location data may be entered by the system user or determined by access to a Global Positioning System (GPS) or other location detection systems. From the location data the requisite times of day (e.g., sunrise, sunset) for effecting operations may be accessed from a lookup table stored in the timer system or may be computed pursuant to established algorithms.

In one embodiment of such an apparatus, an electrical switch provides a means of selecting between a normal mode and a holiday mode. If the holiday mode is activated, the control system overrides normal mode functionality. At the onset of the holiday period the control system fixes the state of the switch in its current on/off state, maintaining that state regardless of the user's physical manipulation of the light switch. In another aspect, the ability to select modes is provided by means of a button to activate a control system for automatically initiating the holiday mode at the beginning of a Jewish holiday and for automatically deactivating the holiday mode at the end of a Jewish holiday.

In a further aspect, techniques may be employed to store a holiday calendar and detect local date, time, and daylight conditions within the apparatus, to facilitate the above functions.

Other aspects and advantages of the disclosure will be apparent to those skilled in the art on reviewing the drawings referenced below and reading the following detailed description.

The above and still further features and advantages of the present invention will become apparent upon consideration of the definitions, descriptions and descriptive figures of specific embodiments thereof set forth herein. In the detailed description below, like reference numerals in the various figures are utilized to designate like components and elements, and like terms are used to refer to similar or corresponding elements in the several embodiments. While these descriptions go into specific details of the invention, it should be understood that variations may and do exist and would be apparent to those skilled in the art in view of the following description.

### BRIEF DESCRIPTION OF THE DRAWINGS

Reference is made to the accompanying drawings, in which:

FIG. 1 illustrates the external view of an installed light switch according to a first embodiment of the invention.

FIG. 2 illustrates the concealed internal view of the light switch of FIG. 1.

FIG. 3 illustrates a mode selection process flowchart according to the present invention.

FIG. 4 illustrates a geographical location data input process for use in the present invention.

FIG. 5 illustrates an Optional Single Push Emergency Activation Button used in the embodiment of FIG. 1.

FIG. 6 illustrates the Optional Combination Emergency Activation Double Push Button in the embodiment of FIG. 1.

FIGS. 7A and 7B illustrate the Optional Sliding Door for a Concealed Switch for Emergency Activation in the embodiment of FIG. 1.

FIG. 8 illustrates the Optional External Holiday Override Button for 24 Hour Lighting in the embodiment of FIG. 1.

FIG. 9 illustrates the Optional Removable Externally Mounted Wall Unit that is Wireless Capable in the embodiment of FIG. 1.

FIG. 10 is a perspective front view of another switch according to a second embodiment of the invention.

FIG. 11 is a perspective view of the switch of FIG. 10 showing a typical mounting orientation with an emergency slider mechanism in its actuated position.

FIG. 12 is a perspective view of the switch of FIG. 10 showing the toggle panel opened to reveal the interior control panel and programming controls.

FIG. 13 is a plan view in elevation of the control panel of FIG. 12.

FIG. 14 is a functional block diagram illustrating program features of the embodiment of FIG. 10.

FIG. 15 is a view of a portion of the control panel of FIG. 13 showing settings for absolute time.

FIG. 16 is a view of a portion of the control panel of FIG. 13 showing settings for selecting delayed time operation.

FIG. 17 is a view of a portion of the control panel of FIG. 13 showing the up/down buttons permitting a user to scroll through program settings.

FIG. 18 is a view of a portion of the control panel of FIG. 13 showing the up/down buttons and mode/enter button for activating the programming mode.

FIG. 19 is a table diagrammatically illustrating the process of setting the date in the system.

FIG. 20 is a functional block diagram of the system.

FIG. 21 is a schematic diagram representing functionally how the system of the present invention responds to signals provided in the functional block diagram of FIG. 20.

FIG. 22 is a diagrammatic illustration of an embodiment of the invention for controlling the hot water valve of a water heater.

FIG. 23 is a schematic diagram showing electrical circuitry in an embodiment of the system of the present invention.

FIGS. 24A-24G are diagrammatic representations of the components of the system and the inter-relationship between the system components in one preferred embodiment of the invention.

FIG. 25A is a bottom view in plan showing one embodiment of an assembled wall switch according to the present invention;

FIG. 25B is a front view in elevation of the wall switch of FIG. 25A with the front cover plate removed.

FIG. 25C is a front view in elevation of the wall switch of FIG. 25A with the front cover plate closed.

FIG. 25D is a left side view in elevation of the embodiment of FIG. 25A;

FIG. 25E is rear view in elevation of the embodiment of FIG. 25A;

FIG. 25F is a right side view in elevation of the embodiment of FIG. 25A.

FIG. 25G is a bottom view in plan of the embodiment of FIG. 25A.

FIG. 26 is diagrammatic representation of the system of the present invention used to control valve operation for a hot water heater.

### DETAILED DESCRIPTION OF THE INVENTION

The following is a detailed description of exemplary embodiments such as those illustrated in the accompanying drawings. The invention should not be understood as limited to the specific embodiments described below.

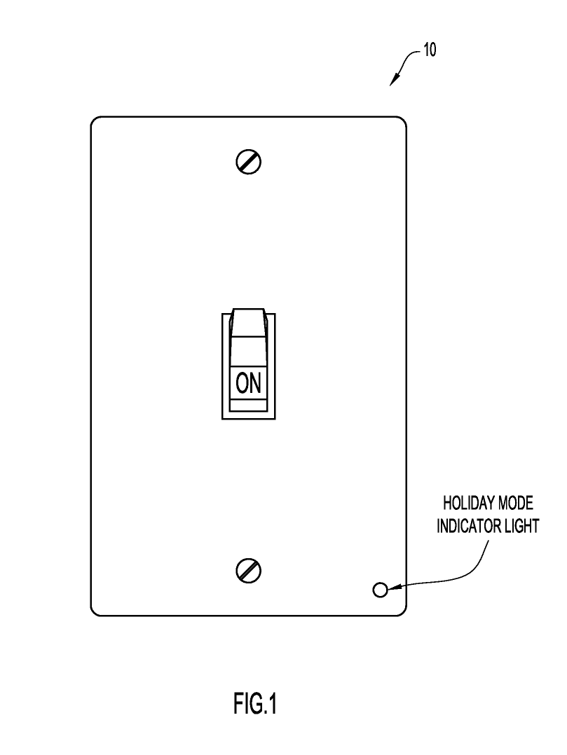

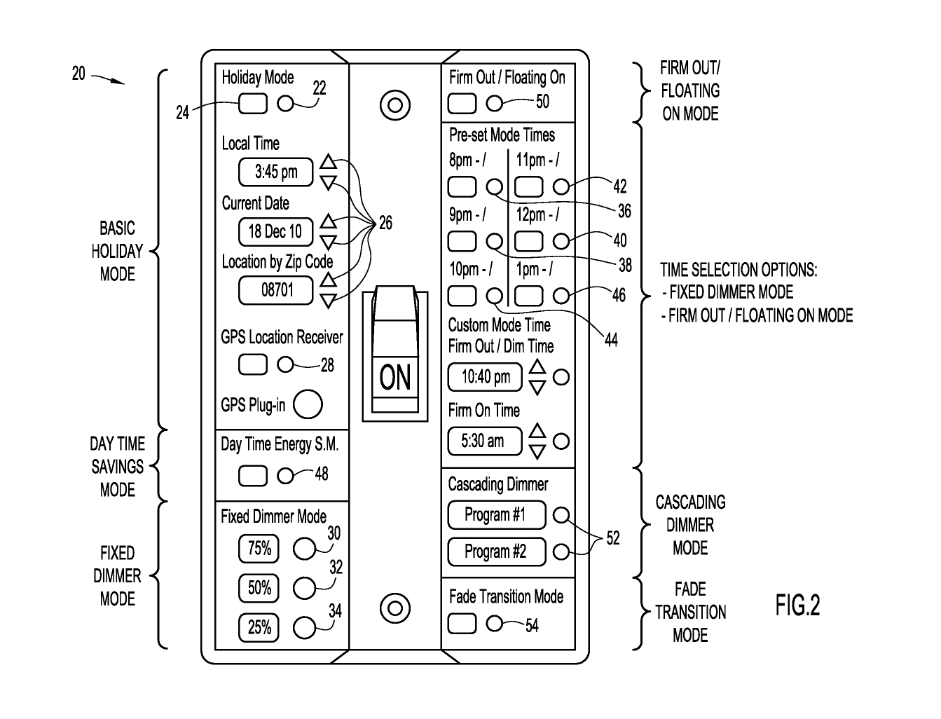

Referring to FIG. 1, in one embodiment, a wall light switch may have particular utility for Jewish people by providing an article 10 that maintains the traditional look and feel of a typical light switch, while concealing a panel 20 of new functionalities that result in an independently functioning light switch capable of operating in a standard mode (e.g., “normal mode”) and Jewish Holiday mode (e.g., “holiday mode”) as depicted in FIG. 2. While the preferred embodiment is presented to the user in a traditional format, an external digital user interface screen could be employed. In addition, the embodiment includes energy saving and preference modes that significantly reduces the homeowner's energy bill while enhancing the holiday experience. By default the wall light switch will operate in normal mode, defined as typical light switch operation commonly in use today. In one example, if holiday mode is activated, the control system overrides normal mode functionality. At the onset of the holiday period the control system fixes the state of the lights in its current on/off state, maintaining that state regardless of the user's physical manipulation of the light switch.

In a further embodiment, holiday mode may be activated by pressing a single activation button 22 as depicted in FIG. 2. After depressing the holiday mode selection button, an adjacent green indicator light 24 turns on to indicate activation of holiday mode. For holiday mode to function in this embodiment, the user must first ensure that the current time, date and geographical location of the device is entered into the system. If the holiday mode selection button is pressed prior to this information being entered, the holiday mode indicator light will flash, indicating that additional data is required by the control system to allow for proper calculation and application of holiday mode functionality. Once fully activated, holiday mode indefinitely applies the fixing and unfixing of the state of the lights controlled by the switch as each successive holiday arrives and leaves.

In such an embodiment, the control system executes this functionality by utilizing software that equates to a digital clock that continuously calculates religiously significant events such as a sunset at the beginning of a holiday and a sunrise during the holiday based on the sun and moon's changing relationship to the apparatus' specific global geographic location in accordance with Jewish Law. The control system in such an embodiment may comprise a microprocessor, software capable of executing mathematical computations, non-volatile memory and a backup battery to provide for the automatic restart of controlling modes after a power failure. For example, the control system may comprise a microprocessor that is capable of executing program logic (e.g., software) in a storage device (e.g., memory) to perform the techniques described herein. In some embodiments, the switch is designed to require the user to enter only the current time, date and geographical location of the device once upon installation or at first use of holiday or preference modes. Alternatively, this information may also be loaded at the place of manufacture or point of sale. The device may further have the capability to maintain and update this data automatically.

To assist user entry of the basic reference data required for the system apparatus to make necessary time related computations, the system in accordance with some embodiments is designed with both manual and automatic means for data entry. In the embodiment illustrated in FIG. 2, the user can manually enter the time, date and location by pressing the up/down scrolling buttons 26 to the right of the corresponding data display. Location data is manually entered by the user through selecting the correct zip code and/or other location identifier information, which has associated latitude, longitude and elevation data stored on the apparatus. This method of associating the complicated geographic data elements of latitude, longitude and elevation with a more familiar and succinct geographical data list, provides a greatly simplified means for entering detailed location data that can be utilized in the mathematical computations for obtaining location dependent religious times based on a combination of the position of both the moon and the sun. In other words, by utilizing the geographic data list, the system apparatus can more readily determine when a Jewish Holiday time has begun. Zip codes are but only one such consumer friendly list that lends itself to this type of association. Other lists include but are not limited to cities, counties, bodies of water, landmarks, street addresses, states, area codes, or other geographically related information or reference points such as schools, synagogues and other community structures and locations.

While the above-described manual process results in a convenient and precise means for determining geographically dependent religious times, the use of wireless internet, cell phone, tower triangulation technology, or GPS technology to automatically enter the three critical data points of date, time, and location, may further simplify an already convenient process, while increasing the accuracy of the religious times to within a space measured in a short distance (e.g., feet or meters) from the apparatus' location rather than from the center of a zip code area or other reference data point area. In the embodiment illustrated in FIG. 2, the data is automatically populated in response to the pressing of a single button 28 on the apparatus under the label GPS

Location Receiver and maintaining the system temporarily in a location where GPS signals are received prior to installation. This operation is powered through the use of a power cord or an internal battery. In some embodiments, the system has the capability of obtaining GPS data through the use of a handheld device separate from the apparatus which collects GPS data at a different location and transmits the data to the apparatus either through a wireless or direct plug-in connection to the installed apparatus.

Once the apparatus in such an embodiment has current date, time and location data, the control system may further provide the user with several energy saving and preference modes by utilizing that particular day's calculated religious times in conjunction with holiday behavior patterns common to most Jewish families to avail the user of a greatly simplified means of programming and automatically adjusting the on/off light timer and dimming overlay functionality during holiday mode. The control system may automatically execute the additional pre-selected modes during the holiday period when the light switch is left in the on position at the automatic fixing of the light. The additional pre-selected modes may override the fixed state of the light left in the on position. The system may further present energy saving and preference modes, e.g. a fixed dimmer mode and pre-set mode times, through a user selection panel. In some embodiments, the modes may be represented by singular push buttons, 30, 32, 34, 36, 38, 40, 42, 44, 46, significantly reducing the complexity of programming the light switch timer and dimming overlay functionality during holiday mode.

Selecting the holiday “Daytime Energy-Savings” mode 48 provided in such an embodiment will automatically turn off the light during daylight hours at a predetermined time in relation to the specific day's calculated time for sunrise and will turn the light back on at a predetermined time in relation to sunset. Further, a selection of several single-push button options for “Firm Out/Floating On” modes 50 may be presented to the user in order to schedule a predetermined shutoff time during holiday evenings that automatically turn the light back on at a predetermined interval before sunrise or sunset. A single-push button option may allow the user to select a custom “Firm Out” time for the “Firm Out/Floating On” mode through a small digital screen with a scrolling time capability for custom time selection. Because the time for sunrise does not remain the same and is constantly shifting throughout the year, this aspect of such a mode is referred to as the “Floating On” feature.

In addition, a selection of several single-push button options for “Cascading Dimmer” modes 52 may be made available to the user to overlay other holiday modes that will prevent an abrupt light shutoff by “stepping down” the percentage of light over a predetermined length of time. For example, the user may select an 11:00 p.m. “Firm Out & Floating On” mode overlaid with a thirty minute Cascading Dimmer mode in the dining room to execute an initial 15% diminution of light at 11:00 p.m. for fifteen 15 minutes, another reduction in light by 20% ten minutes later, followed by an additional 15% reduction for five minutes before the light shuts off completely at 11:30. In this scenario the Cascading Dimming mode allows a relaxed transition during dinner conversation for the first fifteen minutes, ten additional minutes for the traditional Jewish blessing for the food and the final five minutes to casually exit the dining room area before it completely turns dark.

Further in such an embodiment, a single-push button option may activate the “Fade Transition” mode 54 that reduces or eliminates lighting with a steady fading reduction of light over a short period of time to provide the smoothest transition from one programmed level of lighting to the next, including the state of completely off. The mode can be applied to any and all modes previously described.

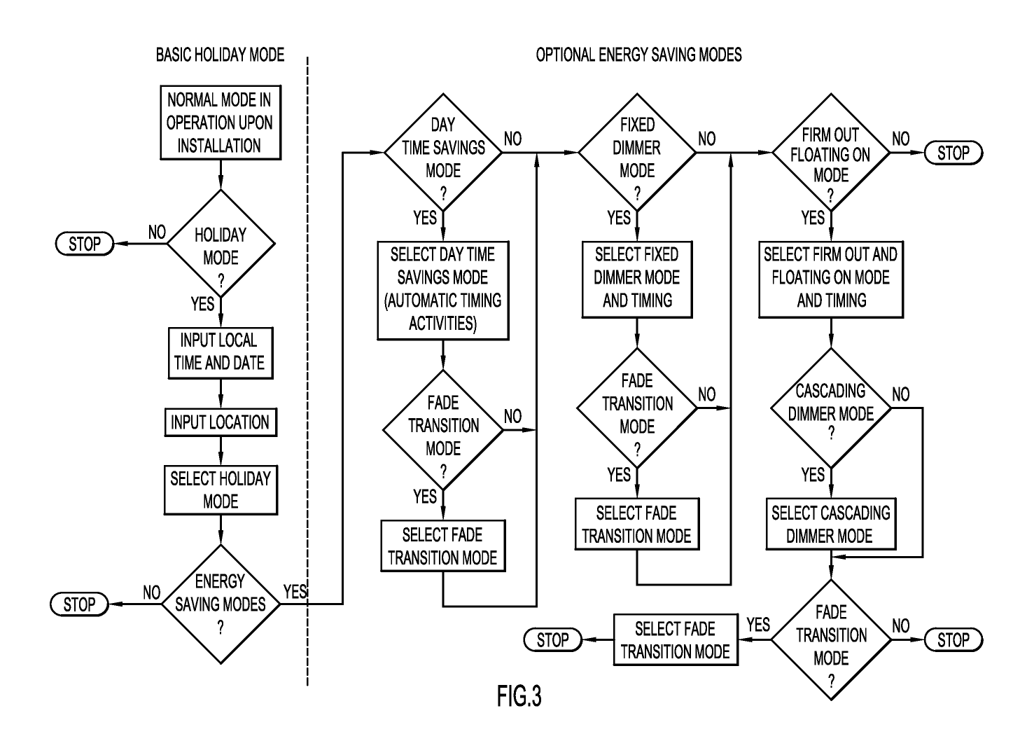

FIG. 3 illustrates a mode selection process flowchart. In some embodiments, the system may function in a basic holiday mode that requires input of time data, and location data. In other embodiments, the system may function in optional energy savings modes.

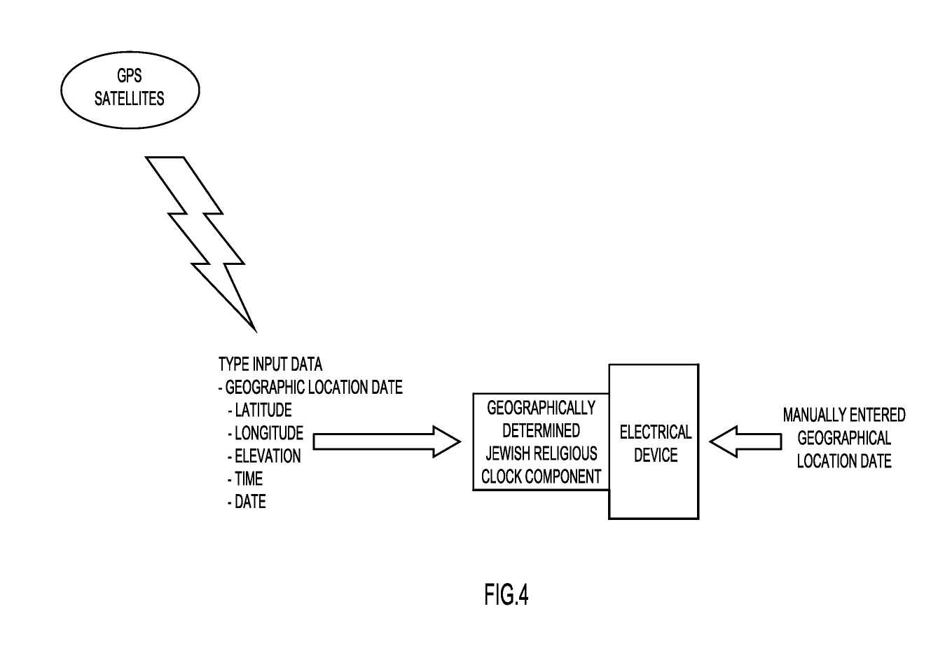

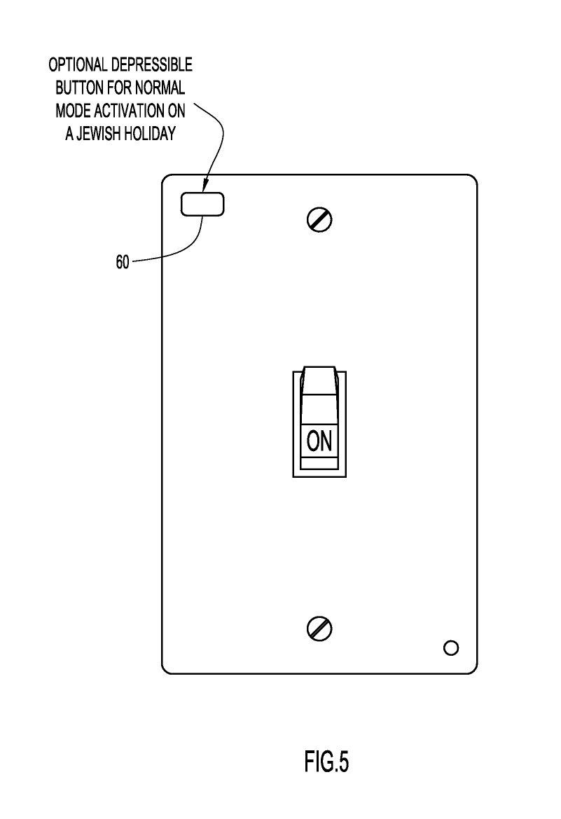

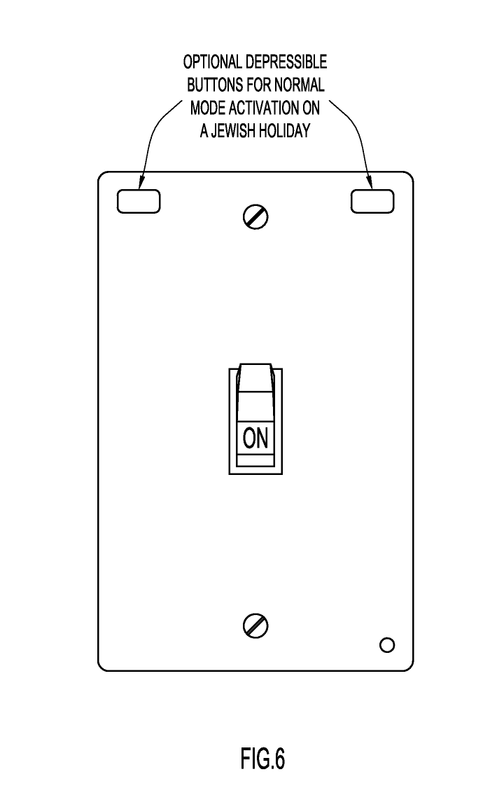

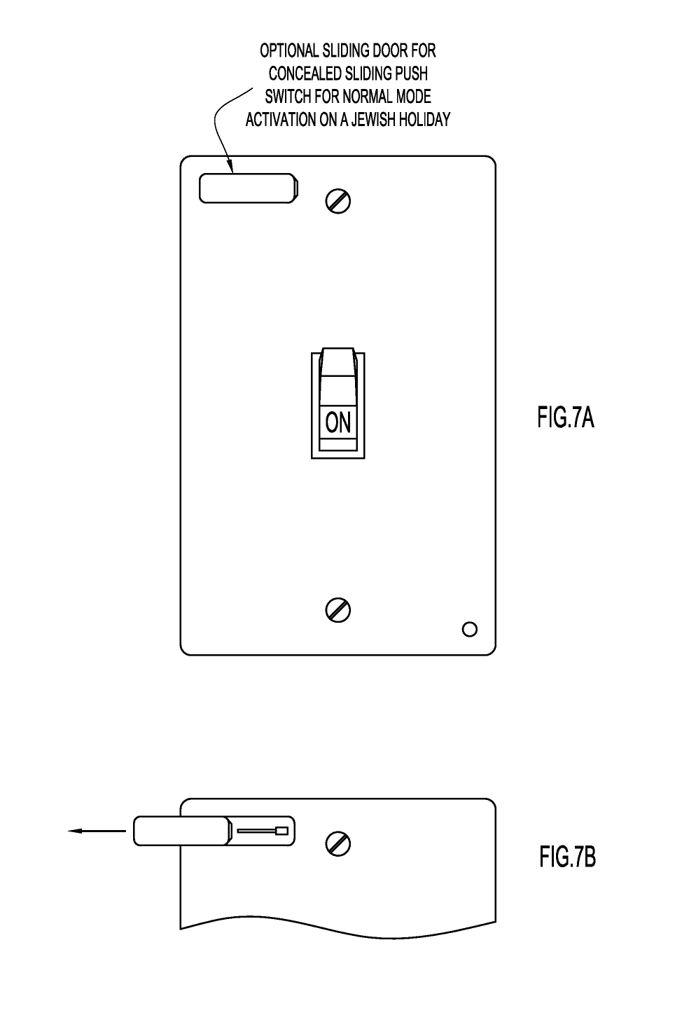

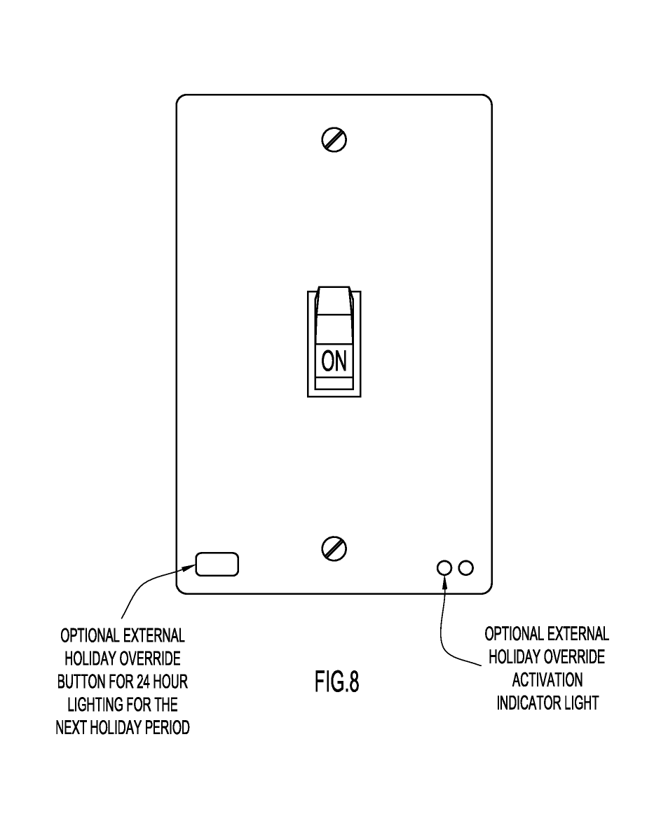

FIG. 4 illustrates the geographical location data input process using a geographically determined Jewish religious clock component. In other embodiments, the system may also include a button 60 for emergency activation of normal wall light switch functionality. In some embodiments, this functionality may be provided through the use of a single flush-mounted subdued push button on the face of the light switch cover as shown in FIG. 5. Alternatively, a two button push combination pattern utilizing two flush-mounted, subdued push buttons on the face of the light switch cover may be provided as shown in FIG. 6. Alternatively, a sliding door with a hidden push button or sliding activation switch may be provided as shown in FIG. 7. Alternatively, optional emergency activation of normal wall light switch functionality may be achieved through use of a cell phone application, as shown in FIG. 8.

In other embodiments, a push button may be provided for deactivating the previously programmed holiday light shut off time for the next upcoming holiday period only. Once pressed, the light will remain on for the duration of the holiday period. In some embodiments, an indicator light may be included to indicate that the holiday mode has been deactivated.

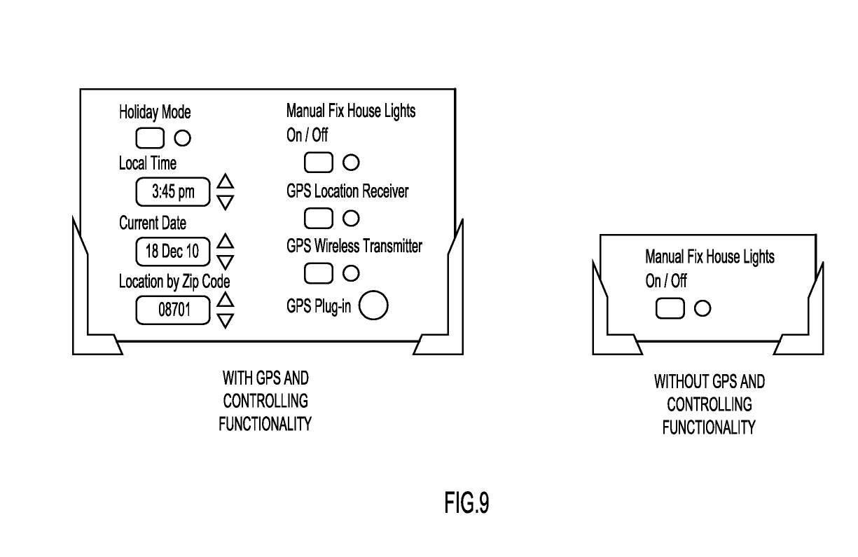

In other embodiments, a removable externally mounted wall unit that is wirelessly capable is provided as shown in FIG. 9. In some embodiments, this externally mounted unit has GPS and controlling functionality. In other embodiments, it does not have GPS and controlling functionality. In the embodiments with GPS and controlling functionality, GPS technology can be used to determine the geographic location of the device.

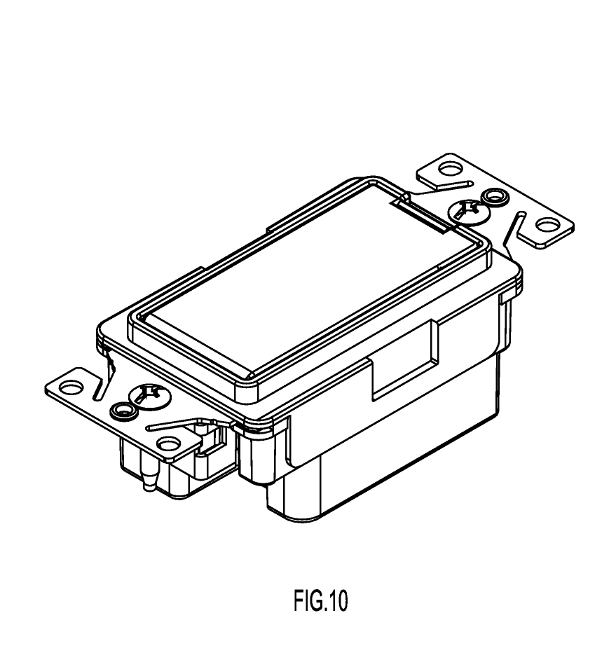

Another light switch system embodiment of the present invention is illustrated in FIGS. 10-20 to which specific reference is now made. The switch unit is preferably designed with a large capacitor operating in a conventional manner to assure that a power failure for as much as seventy-two hours will not result in loss of system settings.

The switch illustrated in FIG. 10 is of the toggle panel type. The form factor of the switch fits in any standard light switch wall mount box and the layout is very close to a normal decorator switch. To access the unit LCD display and the program buttons, the toggle can be opened like a flap, pivoting about its bottom edge as shown in FIG. 12. Any standard decorator cover will fit the switch.

The layout for the internal timer is based on commonly used wiring devices. A mounting strap and ground screw are identical to other wiring devices. The attached wire nuts can be used to wire the timer into an existing circuit.

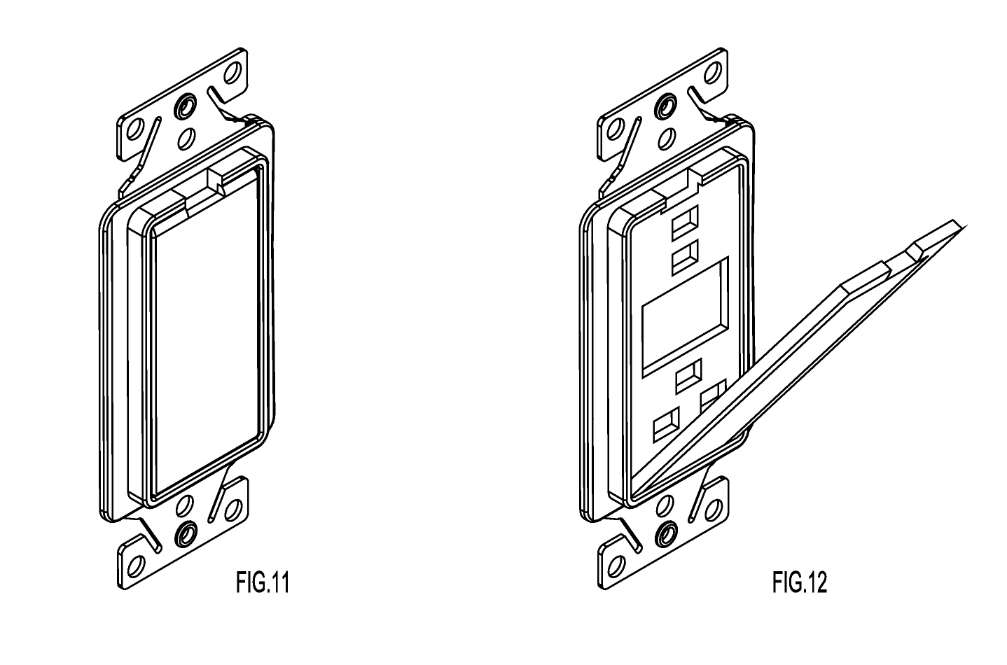

Referring to FIG. 11, in a standard or normal mode the timer looks and functions like a decorator switch. When the software deactivates the light switch in the holiday mode, a red LED below an emergency slider illuminates the slider to indicate the program status and the location of the emergency slider.

FIG. 11 also illustrates the slider, located immediately above the toggle panel longitudinal centerline, moved to the emergency position to override the program functionality. The toggle panel is movable and may be pivoted to change program settings.

To change program settings the toggle panel can be pivoted open about its bottom edge as shown in FIG. 12. In case the toggle is pivoted too far, a conventional mechanical feature prevents breaking the hinge; specifically, the panel will slide out and can be re-inserted without any damage to the timer.

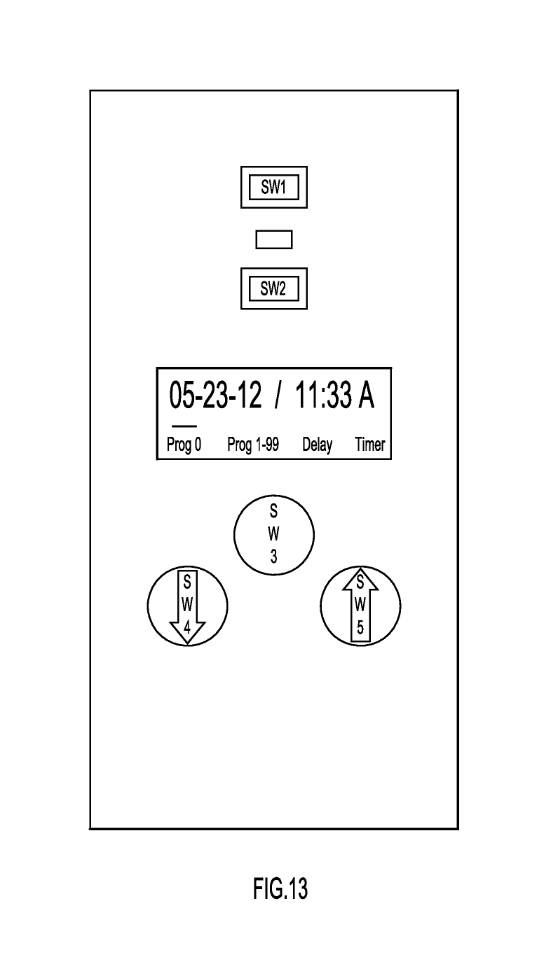

When the toggle panel is open the control panel. Seen in FIG. 13, is exposed to provide access to the programming buttons, the LCD with the status information, and the two switches, to permit programming of the timer. The programming buttons, for example, enable transitions between the normal operating mode and the holiday mode.

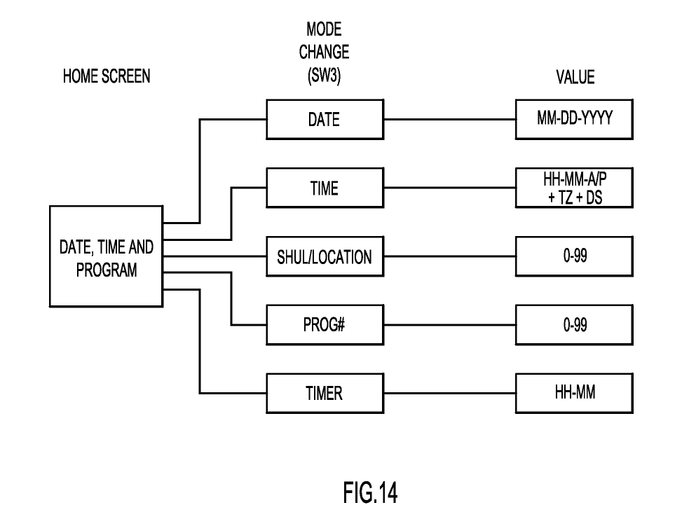

As illustrated functionally in FIGS. 14-16, once the switch unit is connected to a supply voltage, the toggle panel can be opened to access the programming panel. Pressing the MODE button changes the screen into programming mode for Date. First the MM (month) starts to flash, and with the up and down button the value can be adjusted. Pressing MODE again switches to DD (date), and then then again to YYYY (year). Pressing MODE again, the program changes into the Time setting and after this into the Location setting, always using the same syntax to adjust the value with the up and down buttons. Without setting Time, Date and Location only the normal mode can be activated.

In the normal mode the timer acts as a normal power switch, ignoring any Jewish Holidays. In the holiday mode the software in the timer microprocessor will electrically disconnect the power switch from the primary source (i.e., no voltage applied to the switch) during holidays, making it impossible for it to change the state of a circuit (e.g., after sundown). During normal weekdays the switch responds and acts like any normal power switch. Thus, in the holiday mode, the operation of the timer, in effect, disables the power switch from being activated. In the normal mode, the power switch is activated. The software is designed to keep the circuit controlled by the switch in the operational state (i.e., on or off) it was in when upon initiation of the holiday mode. That is, if the light was on it stays on; if the light was off light was off it stays off.

An optional feature of the system is a timer control sub-mode when the system is in the holiday mode. In this mode the power switch is still disconnected during holidays, but the lights or other circuit will be turned on and off controlled by the timer system program. For example, at sundown the timer will turn on the light fifteen minutes before sundown and turn it off at the time programmed, for example at 10:00 p.m. At sunrise the program will turn on the light at the programmed time and turn it off fifteen minutes after sun-up.

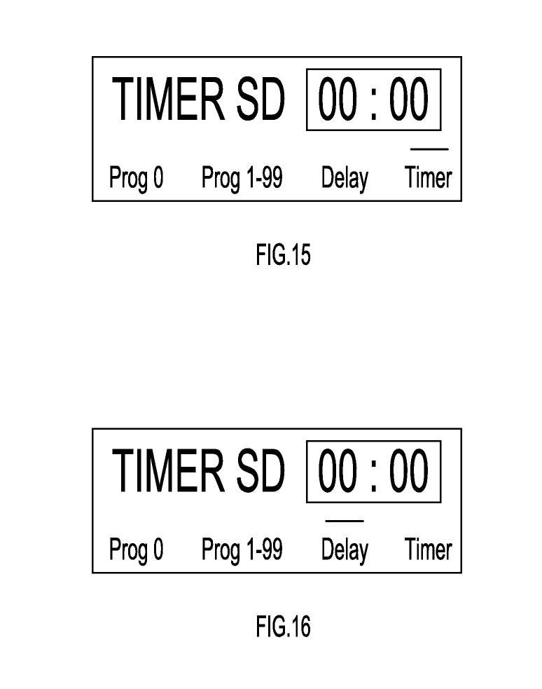

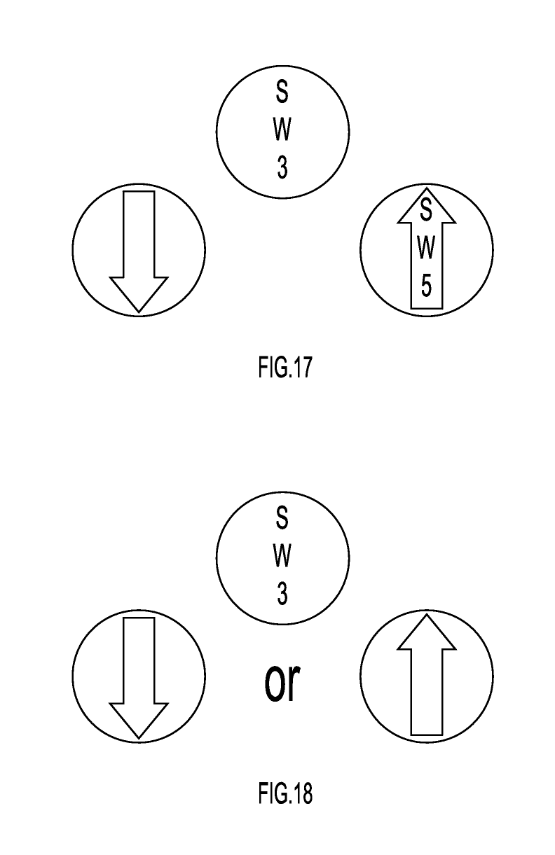

Times can be programed in two modes, either a delay time related to sundown/sun-up or an absolute time. After the system is changed into the timer control sub-mode, the display (FIG. 15) shows SD (sundown) and the indicator flag stands on the timer. This indicates that changes effected with the up and down buttons will be absolute times. Scrolling to a later time than 3 AM in the morning will change the display and sets the flag onto the Delay label (FIG. 16); time adjustments from thereon will be a delay to the current day's sun down time.

Pressing the Mode/Enter button causes the screen to change to the SU (sun-up) settings. The home screen shows general information about the timer status and setup. By pressing the up and down buttons below the LCD, the operator can scroll through all settings and review the settings within any menu (FIG. 17). Pressing the Mode/Enter button on any screen will activate the programming mode (FIG. 18).

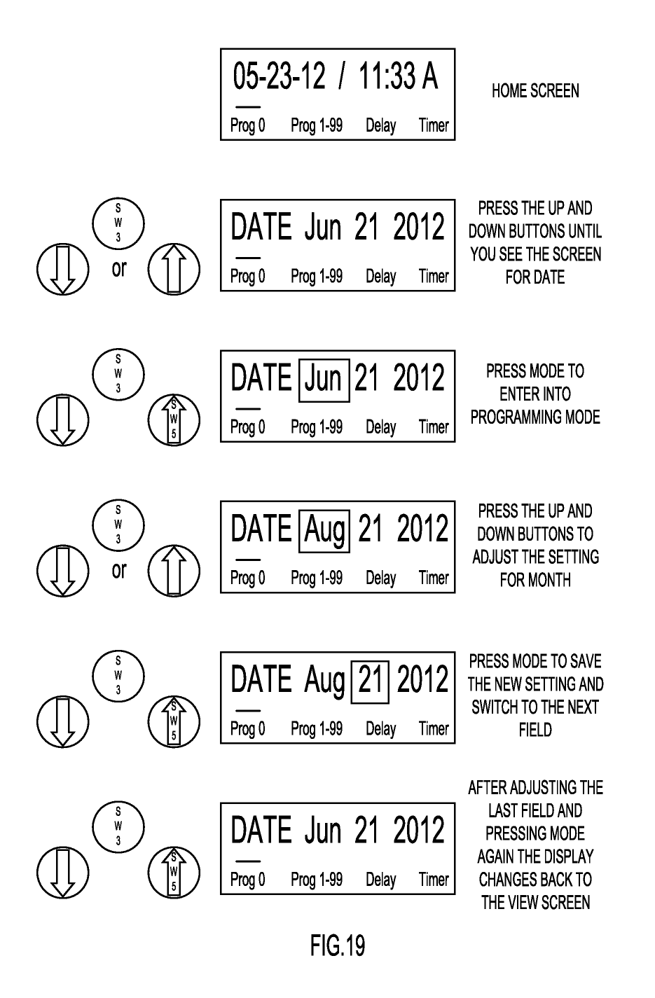

FIG. 19 is a table illustrating an example of the effects of button actuation on the screen display in columns 1 and 2, respectively, with a description of these effects indicated in column 3.

To setup the timer several date entries are necessary, and in the background several conditions for the program functions have to be realized.

Time: For the timer to work as expected, additional information regarding time settings is required. The additional information is only displayed in programming mode:
Time Zone: ET; CT; MT; PT
Daylight Savings Time (DST): yes; no

Location: For up to thirty locations the timer has a lookup table in the background to fill the required information into the program code. In this exemplar lookup table the longitude and latitude are preset. For example:
1. Lakewood, N.J.: N40°6′; W74°12′
2. Montreal, QE: N45°31′; W73°33′
3. San Francisco, Calif.: N37°46′; W122°26′
4. Etc.
.
.
30. Etc.

The preset can be used if the geographic location of the user's home is within a radius of about twenty miles (about 15′) of the city center. Therefore the calculated times are offset by three minutes. To adjust for potential errors, this also requires that in case the location is not in the lookup table the precision must be within +/−15′ for latitude and longitude.

Other options to setup the location are to use today's sunrise and sundown times to allow for a back calculation or to type in Latitude and Longitude directly.

Holidays: All Jewish Holidays are stored in a lookup table to compare the Gregorian calendar date to the Jewish calendar. Days that are expected to be a “Jewish Holiday” are flagged with a symbol. The same logic is behind the flag for daylight savings time to adjust the time at the correct date. For example:

| Gregorian | Jewish | Holiday | DST |
|---|---|---|---|
| Jun., 20, 2012 | 30 Sivan, 5772 | no | yes |
| Jun., 21, 2012 | 31 Sivan, 5772 | yes | yes |
| Etc. | | | |
| Etc. | | | |

The lookup file has typical data of the following type:
41080;30 Sivan, 5772;0;1
41081;31 Sivan, 5772;1;1

Sunrise/Sundown: Sundown and Sun-up programs can be downloaded as BASIC programs with the complete algorithm valid for the next 800 years. For example, see:
http://www.skyandtelescope.com/resources/software/3304911.html?page=1&c=y
http://aa.usno.navy.mil/faq/docs/rs_algor.php

Preset Programs

The function of the preset programs is to fill in the variables for the timer with preset values. The following table shows the sets:

| Prog# | Sun Down Timer | Type | Sun Rise Timer | Type |
|---|---|---|---|---|
| 1 | 1:00 A | Time | 1:12 | Delay |
| 2 | 11:30 P | Time | 0:00 | |
| 3 | 1:00 A | Time | 0:00 | |
| 4 | 2:30 | Delay | 1:00 | Delay |

Still referring to FIG. 19, the table illustrates the setting of the date in the system; that is, various modes are shown whereby the date of the system can be adjusted. For example, in one mode, the month, day, year and other features may be adjusted by engaging various buttons of the control panel. In another mode, after adjustment of the dates has been made, the system can function with the programmed dates.

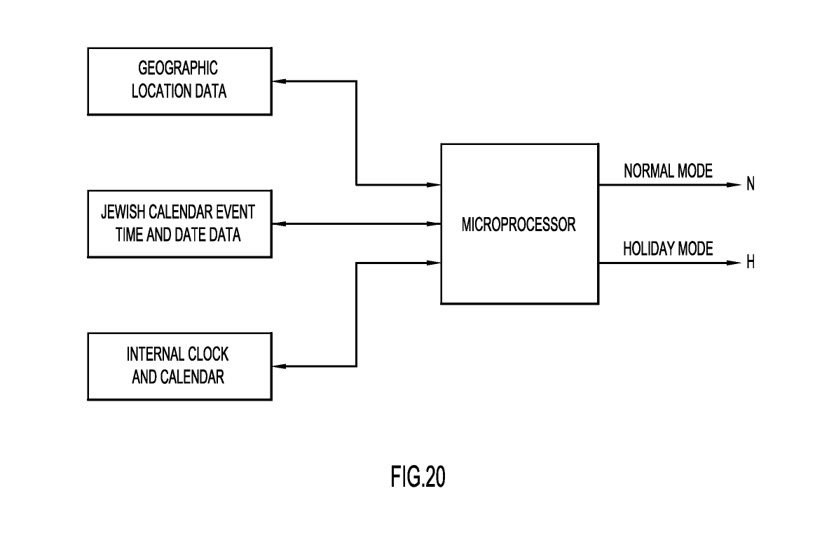

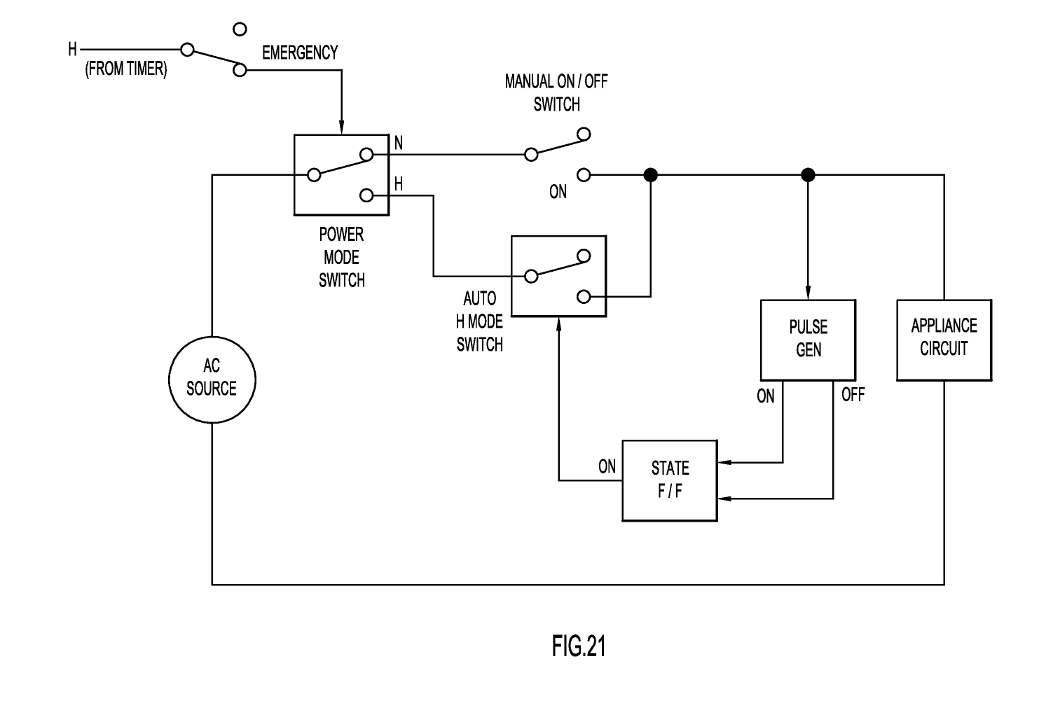

FIG. 20 illustrates a functional block diagram showing one example of overall operation of a system according to the invention. The stored geographic location data, the Jewish calendar event time and date data, and the internal clock and calendar interact via the microprocessor to provide alternative Normal (N) and Holiday (H) signals when the system is in the corresponding mode.

FIG. 21 is a schematic diagram functionally illustrating one example of the logic that determines system operation. Specifically, this diagram illustrates how the system functions to prevent an electrical power switch from changing the state of current flow through any appliance, or lights or device in the holiday mode of the system. In the normal mode (i.e., in the absence of the holiday mode signal H), voltage from the primary power supply is applied from the power mode switch terminal N to the manually actuable on/off switch of the controlled appliance or circuit. In this condition the appliance or circuit operates conventionally, either turned on when the manual switch is in its ON position, or turned off when that switch is in its OFF position.

When the system establishes a holiday mode in the manner described above, the holiday signal (H) from the microprocessor causes the power mode switch to assume its H position, thereby disconnecting primary power voltage from the manual on/off switch. Instead, that voltage is applied to the Auto H Mode switch which, depending on its position, may connect the primary power voltage to the appliance circuit or not. The position of the Auto H Mode is determined by the condition of the State flip-flop which in turn is determined by the state of the appliance circuit at the time the H signal is activated.

Specifically, a pulse generator is connected to the primary voltage line at a location downstream of the manual on/off switch. When that on/off switch is turned on the pulse generator provides an ON pulse which places the State Flip/Flop in its ON state. The ON signal from the flip-flop actuates the Auto H Mode Switch so that, when the holiday mode is entered (the H signal is received) the primary voltage remains applied to the appliance circuit through the Auto H Mode switch rather than through the manual on/off switch.

When, in the normal mode, the manual on/off switch is turned off, an off pulse is provided by the pulse generator to trigger the flip-flop to its OFF state which is also the default state of the flip flop. Now, when the H signal is received, with the flip flop in the off state, the Auto H Mode switch is turned off and cannot apply primary voltage to the appliance circuit.

Therefore, for as long as the system is in the holiday mode, the state of current flow through the appliance circuit (i.e., on or off) will remain the same as it was when the holiday mode was established. When the system returns to the normal mode, the H signal is removed and control of appliance operation is returned to the manual on/off switch.

A manually actuable emergency switch is provided in the current path for the H signal between the microprocessor and the power mode switch to permit disruption of the effect of the holiday mode in an emergency wherein the appliance must be turned off or kept off. Specifically, the emergency switch is normally closed and can be manually opened to prevent the H signal form actuation the power mode switch, thereby keeping that switch in the Normal position irrespective of whether the system is in the Normal or Holiday mode.

The appliance circuit illustrated in FIG. 21 may be an electric light circuit, a refrigerator, a coffee maker or other water heating pot, a hot plate, a plug-in wall timer, a dishwasher, a television set, a radio, an alarm clock, an electric watch, an oven (microwave, electric), a stove, a fan, an air conditioner, a furnace, a hot water valve, an electric lock, a motion detection home security device, or any other conventional appliance or device activated by electric current controlled by an electronic or manual switch. In addition, the appliance may be an electrical receptacle for an electric plug, the receptacle being kept “hot” (i.e., voltage applied across its terminals) or not in the holiday mode depending upon its state when the holiday mode was entered.

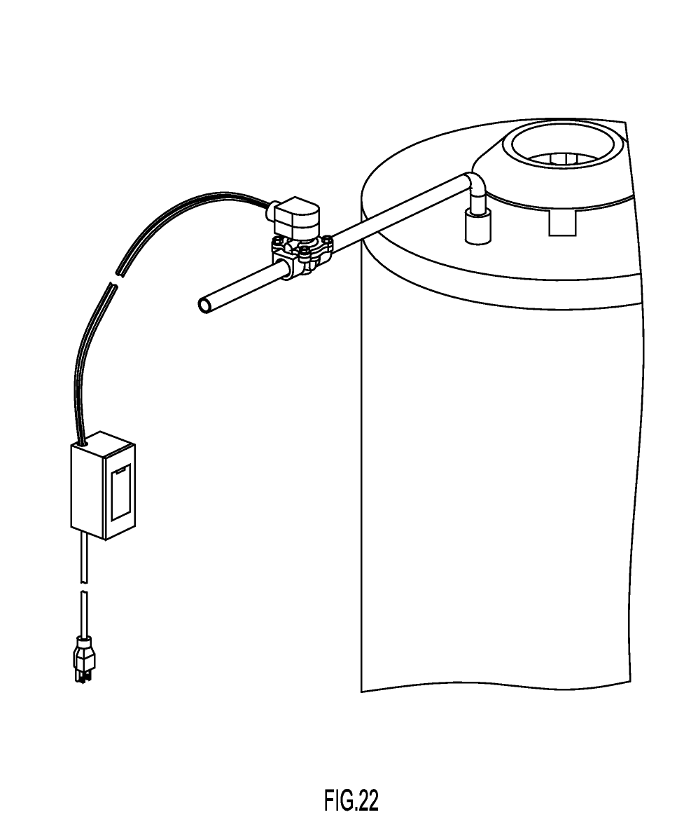

FIG. 22 illustrates a system operating to control a hot water valve in a hot water heater. The timer system of the present invention is connected by an electrical plug to convenience power and is wired to the controller of the hot water valve, as shown, to override application of voltage to the valve in the holiday mode.

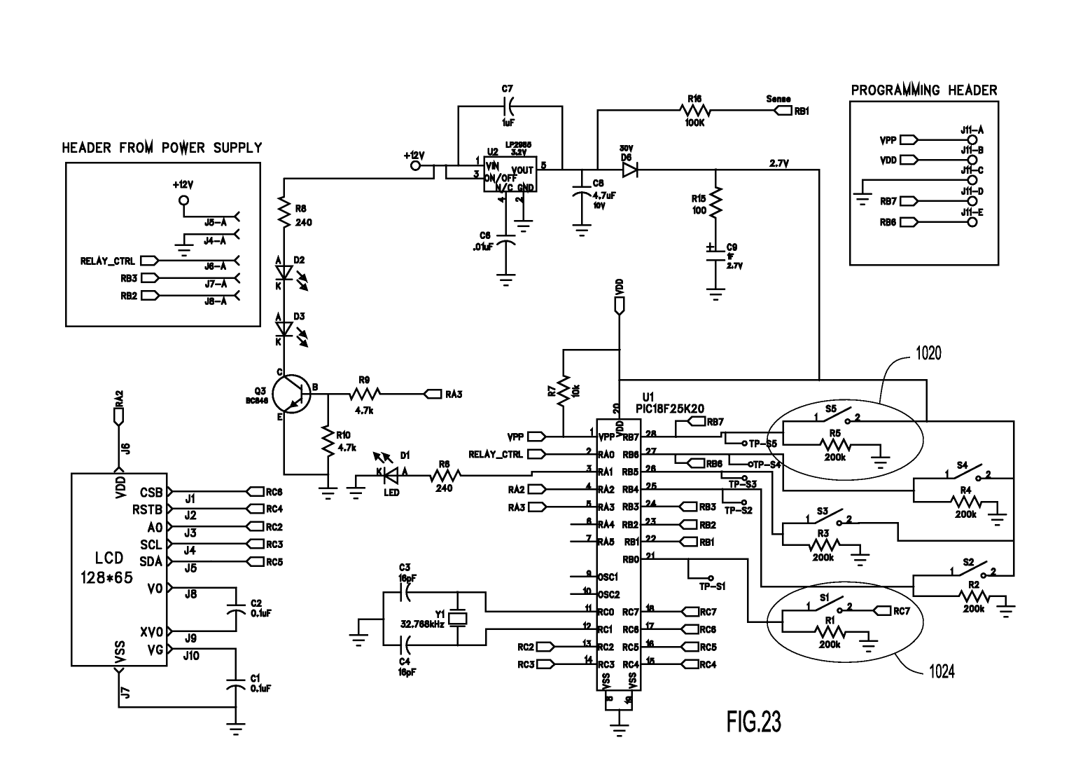

FIG. 23 is an example schematic diagram showing electrical circuitry of the system of an embodiment the present invention. System operation is controlled by microcontroller U1. At reference numeral 1020, the emergency switch S5 is depicted. Switch S5 is shown in an “open” position, although it should be appreciated that switch S5 may be in an open position or in a closed position. In the schematic, at pin 2 of switch S5, 2.7 volts of Direct Current (DC) is supplied by a power source. When switch S5 is in an open position, pin 2 will be at 2.7 volts and pin 1 will be at zero volts. Since pin 1 is connected to the microcontroller U1, the microcontroller reads a low voltage, which indicates to the microcontroller a “not pressed” button state for the emergency switch. When switch S5 is in a closed position, the voltage at pin 1 is 2.7 volts, which is the same as the voltage at 2. The microcontroller then reads a high voltage, which indicates to the microcontroller a “pressed” button state for the emergency switch.

At reference numeral 1024 in FIG. 23, switch S1 illustrates how a main switch operates. Pin 2 of switch main switch 51 is connected to output terminal RC7 instead of the 2.7 voltage source. During normal or “non-Sabbath” periods, terminal RC7 is set to be “on,” thus making the voltage at RC7 and pin 2 of switch S1 high (i.e., 2.7 volt). Because the voltage at pin 2 is high, the main switch S1 functions as a normal power or main switch. During the holiday mode, however, RC7 is set low, e.g., zero volts. Thus, the input pin 1 of switch S1, connected to pin RBO of microcontroller U1, is also low. When RC7 and RB0 are low, there is no voltage at pin 1 or pin 2 of switch S1. As a result, there is no potential across the two switch S1. In this condition, if the main power switch S1 is pressed by someone, a no high or 2.7 volt signal to is sent to pin RB0 of microcontroller U1 to toggle the light. Furthermore, the microcontroller's program is not checking pin RB0's state because RB0 is set to an output rather than an input. Accordingly, the main switch S1 does not send a signal, while the microcontroller is simultaneously not looking for one.

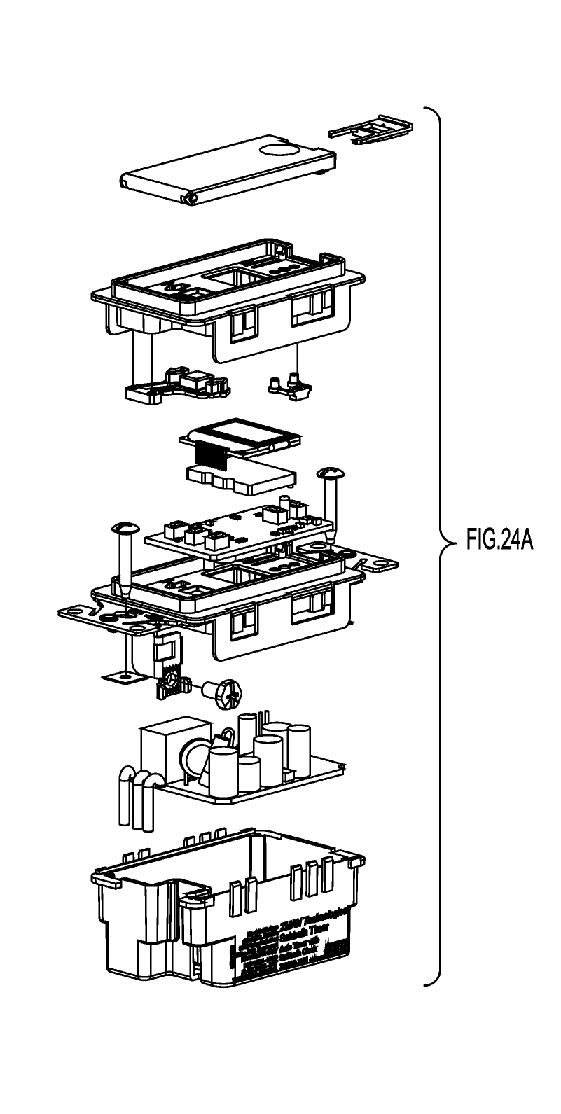

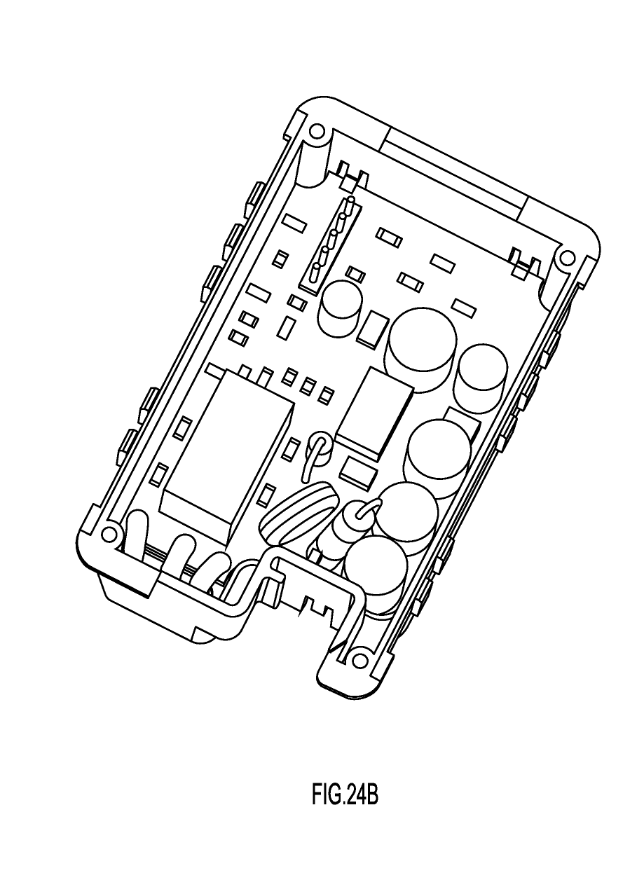

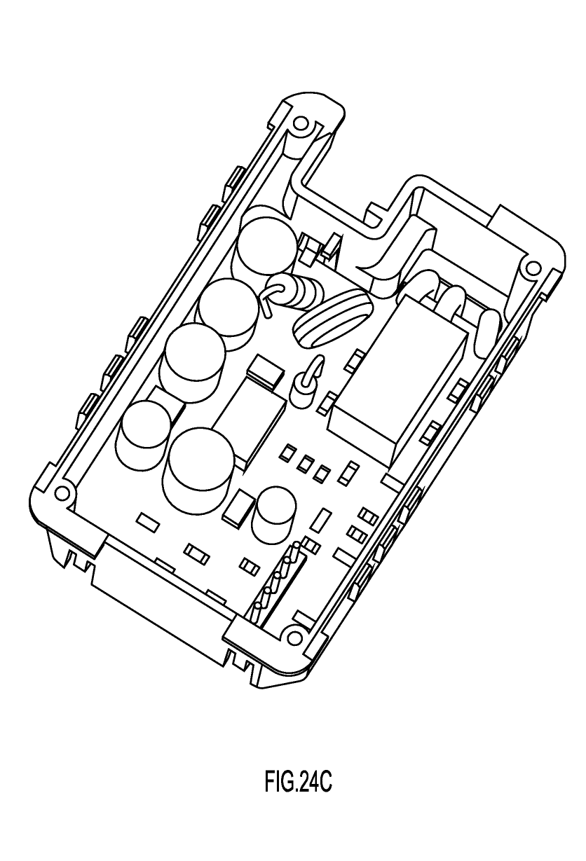

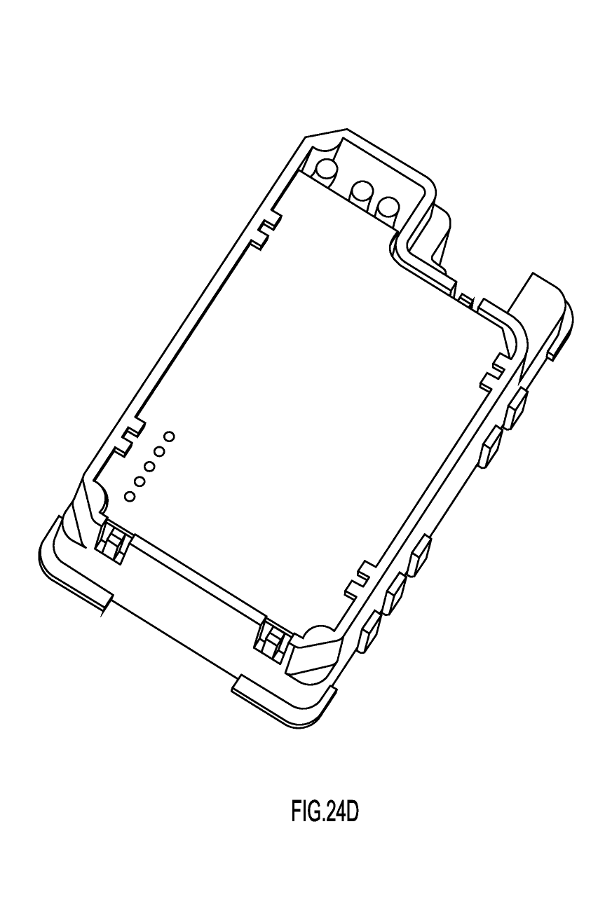

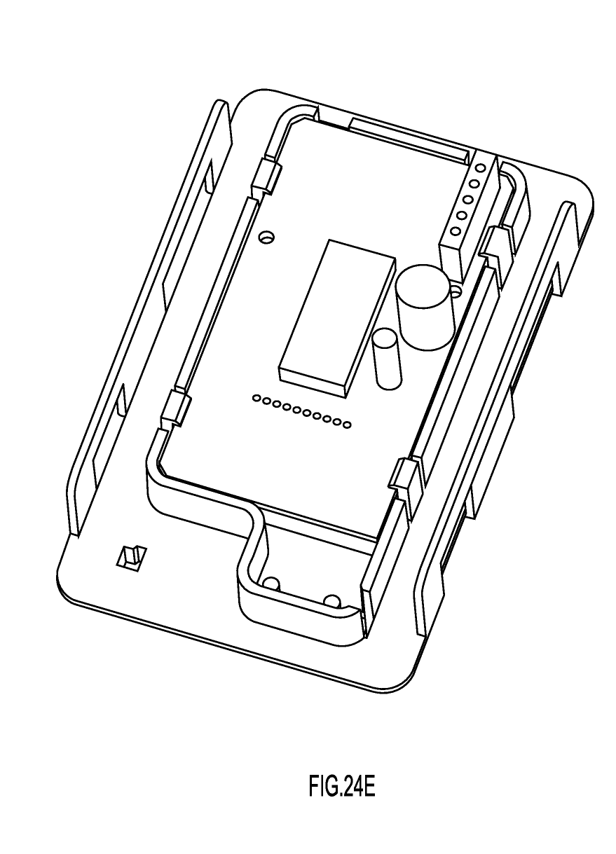

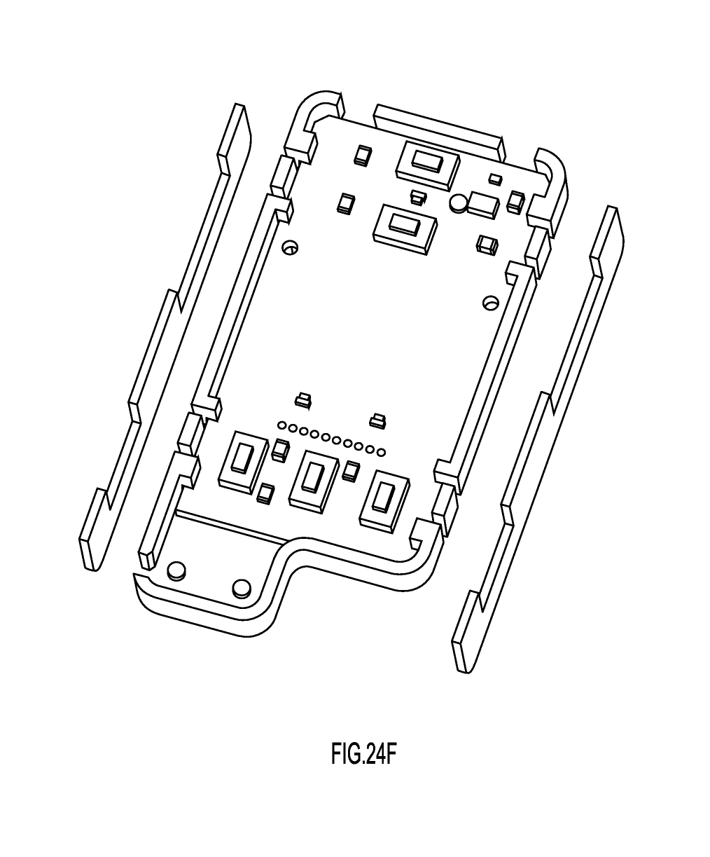

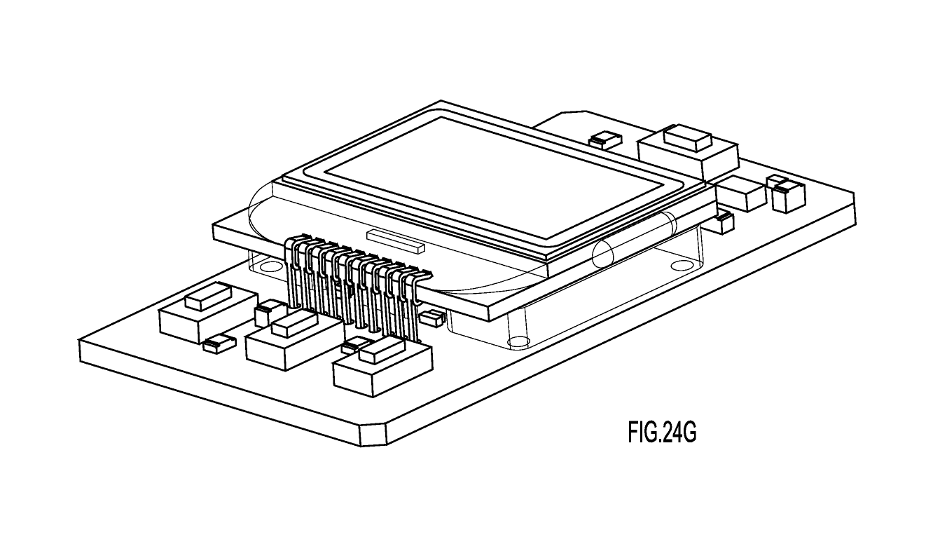

FIGS. 24A-24G are diagrammatic representations showing the inter-relationship between the different components of the system. For example, in FIG. 24A, various components of the system are shown, including, but not limited to, a display module, strap, ground screw, mounting screw, mounting screw washer, bottom housing, toggle, slider, top printed circuit board (PCB), bottom PCB, programming buttons cover, activation button cover, light emitting diode (LED) backlight diffuser, top frame and bottom frame. FIGS. 24B-24G show one or more of these components in different orientations.

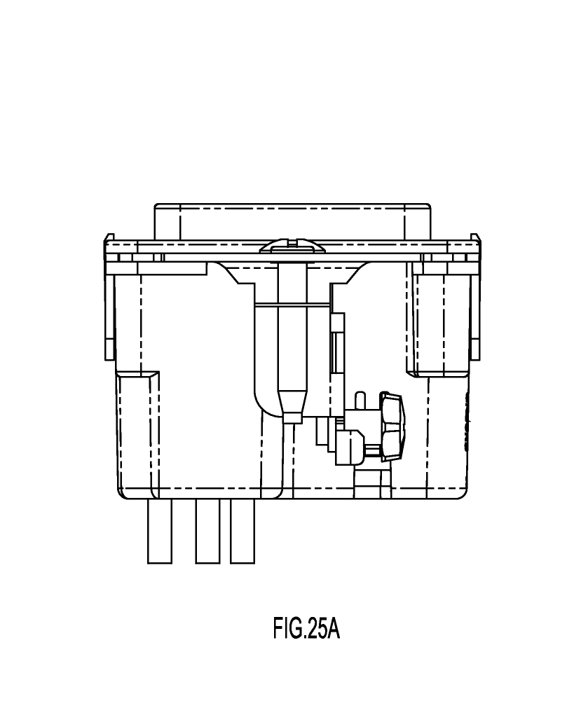

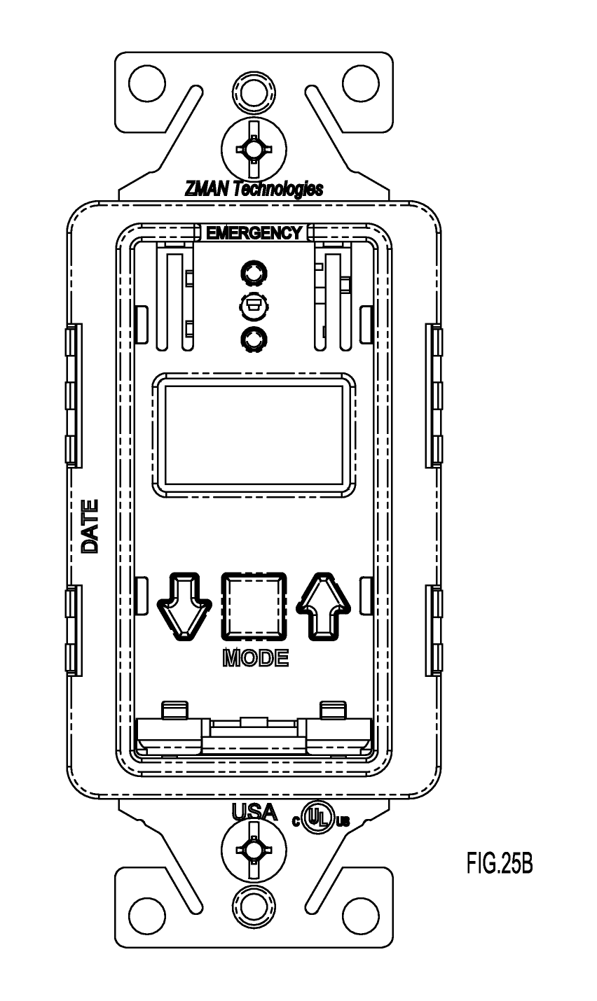

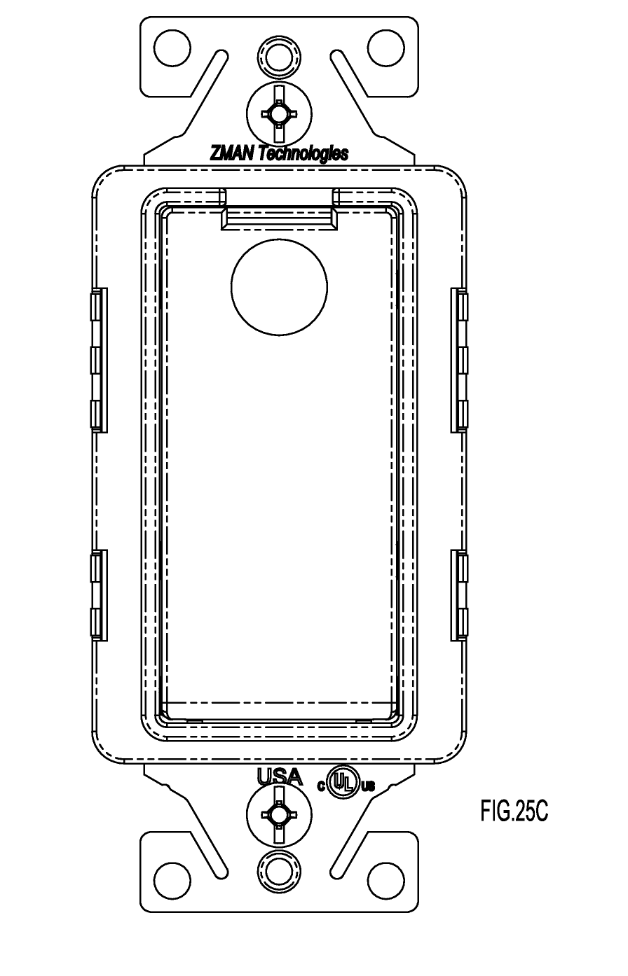

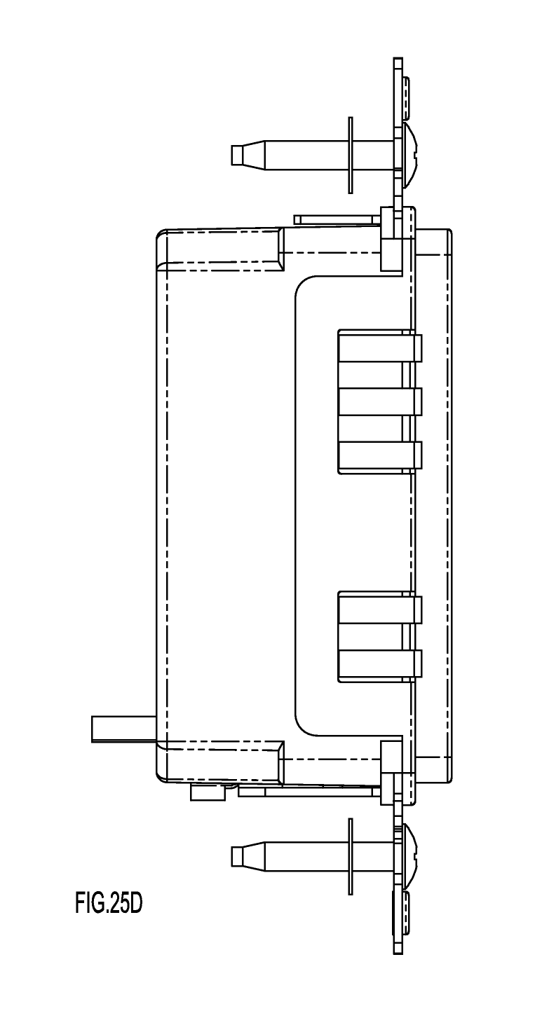

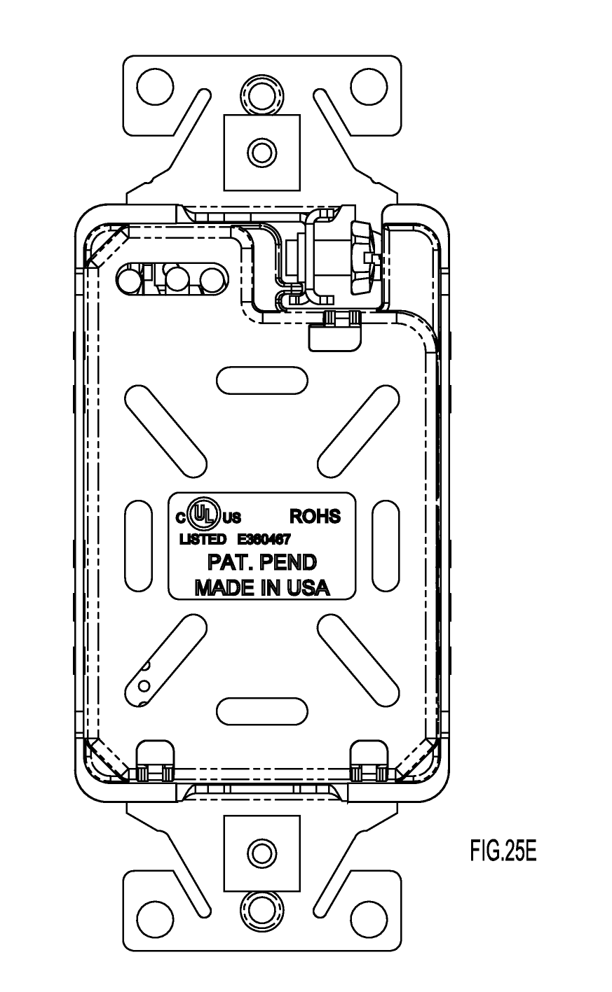

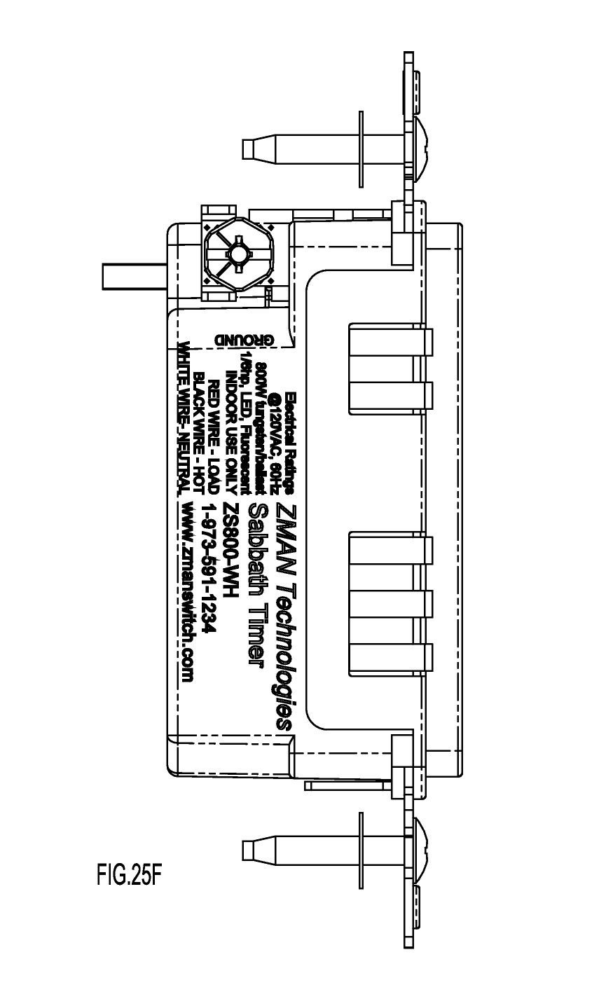

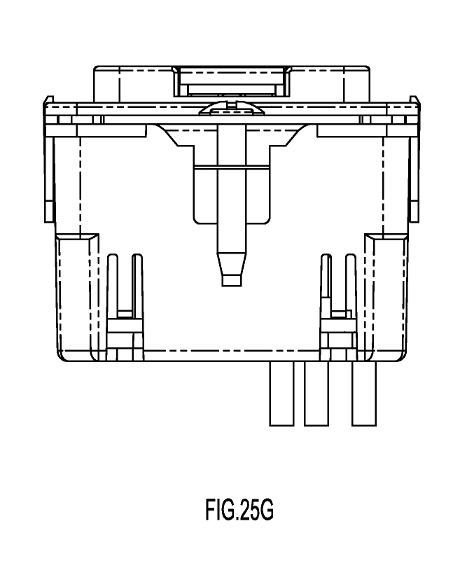

FIGS. 25A-25G show example representations of the control device of the system as described herein. For example, FIGS. 25A-25G show the control device from various views, including, but not limited to a top, bottom, left side, right side, front and rear view.

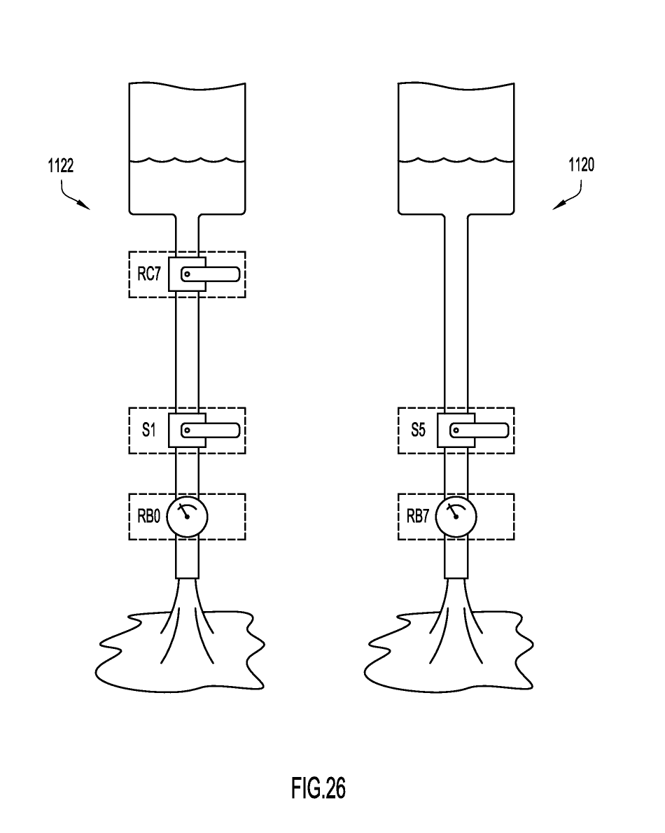

FIG. 26 is an examplar diagrammatic representation of the system of the present invention used in a plumbing apparatus. FIG. 26 shows, at reference numeral 1120, a plumbing apparatus that comprises a water reservoir above a valve controlling the flow of water going through the flow meter and onto the floor. Due to the gravitational pull, the water has potential energy to flow down through the plumbing. When the valve is opened, water will flow and the flow meter will indicate the number of gallons per hour. The flowing water is analogous to the flow of electrical current. In other words, just as electrical current cannot flow through an open switch, the water cannot flow if a valve is closed. The plumbing apparatus at reference numeral 1122 shows a water reservoir with two valves controlling the flow of water through a flow meter. When the top valve is opened, the flow of water will be determined by the state of the bottom valve. This is similar to when RC7 of the microcontroller is high, whereby switch S1 determines what is read by RB0. When the top valve is closed and all of the water below the top valve is allowed to exit the plumbing, opening and closing the bottom valve (S1 in FIG. 26) will not alter the reading on the flow meter. The flow meter will read zero gallons per hour. This is analogous to how RC7 of the microcontroller, at a low output voltage during the Sabbath period (i.e. holiday mode) causes the main switch to have no potential across its pins.

The system of the present invention is, in effect, a sophisticated electronic timer switch for overriding any manually actuable switch that controls current flow through an electric circuit, where the override occurs at recurring times that are different from day to day and are determined by the time of year, the time of day and the geographic location of the circuit. One particularly practical application of the system is in the prevention of change in the state of current flow via the manually actuable switch during holiday times as set forth in Jewish Law.

The system of the present invention completely eliminates the need to physically tape or otherwise cover light switches and other switches, and eliminates the risk of accidental or intentional change in operational state of the light or appliance on a Jewish Holiday. In addition, the system incorporates methods for simplifying the application of energy saving and preference modes that, if selected, will greatly reduce energy usage and costs through the use of the on/off light timer and dimming overlay functionality applied during holiday mode.

In one aspect, the invention provides means for obtaining date, time and geographic location data and combining it with electronic and/or mechanical devices to enable the control system to operate the apparatus in accordance with Jewish Law by utilizing the resulting religious reference times that are calculated from the sun's and moon's relationship to the device's specific geographic location. This method of operating switches in accordance with Jewish Law equally applies to substantially any appliance that is manually activated by an on/off switch. However, this method of obtaining date, time and geographic location data and combining it with Jewish Law has a dual application for many products that are not Jewish-specific as well, such as the timing of landscape watering systems, operation of video equipment, automatic door locking systems, pet food dispensing systems, etc.

Energy saving and preference modes as described herein in connection with certain embodiments utilize the geographic location, date and time to enable the automatic programming and control of systems based the sun's and moon's relationship to a system, resulting in a significant reduction in management, energy usage and other associated costs.

In one preferred embodiment the present invention provides observant Jews with a switch that can serve as a timer throughout the week and then become disabled, preferably automatically, just prior to Sabbath and on all Jewish holidays. The switch may be wall-mounted to control lights or it can be connected in a circuit to control an appliance. The switch is programmed to know when exactly this timing occurs for some predetermined time period (e.g., from the present through the year 2050 or longer).

Upon initial start up the time of day is entered, either manually by the user or automatically by synchronization with an external standard. The user must also enter his/her location (either by a preset city installed in the unit or by longitude and latitude) and the date. Alternatively, the location information may be entered automatically via GPS o the like. The unit offers some flexibility in selecting on-off cycles, both during the week and on the Sabbath.

Other features of the switch:

The switch will maintain the settings for up to seventy-two hours in case of power outage, a feature achieved by means of a large storage capacitor.

The switch is back lit.

The switch has a manual override feature for use in case of emergency

The switch uses a diagnostic LED to show the user status of the unit.

The switch uses visual icons in the LCD to show the user the modes and programs

While the invention has been described in terms of specific embodiments, those skilled in the art will recognize that the invention can be practiced with modification within the spirit and scope of the claims.

Having described preferred embodiments of new and improved methods and apparatus for controlling operations and signaling at times dependent on the time of year, time of day and geographic location, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation

We claim:

1. A method for controlling the effect of manual actuation of an electric switch in an electrical circuit at specified times comprising the steps of:
(a) establishing a normal mode in which manual actuation of the switch effects a change in a state of current flow in the circuit;
(b) establishing a holiday mode as an alternative to the normal mode and in which manual actuation of the switch has no effect on current flow in the circuit; and
(c) switching from the normal mode to the holiday mode at said specified times corresponding to specified events dependent on the time of year, a time of day and a geographic location of the circuit.

2. The method of claim 1, wherein switching comprises switching from the normal mode to the holiday mode automatically as a function of the time of year, a time of day and a geographic location of the circuit.

3. The method of claim 1, further comprising automatically switching back from said holiday mode to said normal mode after predetermined time intervals in said holiday mode corresponding to respective durations of said events, wherein said durations are dependent on the time of year, the time of day and the geographic location of the circuit for each event.

4. The method of claim 1, wherein switching from the normal mode to the holiday mode comprises:
obtaining data pertaining to the geographic location of the circuit;
determining, at a particular time of day, based on the data pertaining to the geographic location, that the switch is to automatically switch from the normal mode to the holiday mode.

5. The method of claim 1 wherein said specified events are Sabbaths, holidays and festivals established under Jewish Law.

6. The method of claim 1 wherein the electric circuit includes at least one electric light.

7. The method of claim 1 wherein the electric circuit includes at least one electrical appliance.

8. The method of claim 7 wherein said electrical appliance is selected from the group consisting of refrigerators, coffee makers, water heating pots, dishwashers, television sets, radios, ovens, clocks, watches, fans, air conditioners, furnaces, hot water valves and electric locks.

9. The method of claim 1, further comprising storing data representing said specified times at the geographic location of the circuit.

10. The method of claim 1 wherein the electric circuit includes at least one electric light, the method further comprising the steps of automatically adjusting an amount of illumination provided by said electric light from a first illumination setting to a second illumination setting, and establishing at least one time at which the adjustment of the amount of illumination occurs.

11. The method of claim 1 further comprising the step of selectively establishing an emergency mode in which the switch when in the normal mode cannot be switched to the holiday mode, and when in the holiday mode is automatically switched to the normal mode.

12. A system for automatically controlling, at specified times, the effect on an electrical circuit of manual actuation of an electrical switch, said system comprising:
an electrical timer for alternatively establishing a normal operational mode and a holiday operational mode;
means responsive to said normal mode for permitting manual actuation of the electrical switch to effect a change in current flow in the circuit;
means responsive to said holiday mode signal for preventing manual actuation of the electrical switch from having any effect on the state of current flow in the circuit;
wherein said timer includes:
means for normally establishing said normal mode; and
means for inhibiting said normal mode and establishing said holiday mode at said specified times corresponding to predetermined events dependent on the time of year, the time of day and the geographic location of the circuit.

13. The system of claim 12 wherein said timer includes means for automatically setting the durations of said events as functions of the time of year, the time of day and the geographic location of the circuit.

14. The system of claim 13 further comprising a manually actuable emergency switch for selectively establishing an emergency mode in which the switch when in the normal mode cannot be switched to the holiday mode, and when in the holiday mode is automatically switched to the normal mode.

15. A programmable control device in an electrical appliance comprising:
a switch for selectively applying electrical current to and removing electrical current from the appliance;
a memory for storing date data, time data, geographic location data, settings corresponding to a holiday mode and settings corresponding to a normal mode; and
a processor configured to alternate the device between the normal mode and the holiday mode, wherein in the normal mode the switch is operational and wherein in the holiday mode the switch is non-operational.

16. The device of claim 15, further comprising:
user controlled input means for permitting the processor to automatically alternate between the normal mode and the holiday mode as a function of the stored date data, time data and geographic location data.

17. The device of claim 15 further comprising user input means disposed on an external unit for initiating wireless communication of at least one Jewish event from the programmable control device to at least a first other programmable control device.

18. The device of claim 15 wherein the memory contains software capable of storing and determining dates and times of Jewish events.

19. The device of claim 18 wherein the processor calculates an occurrence of a Jewish event by utilizing time, date and location data and Jewish law.

20. The device of claim 19, further comprising a GPS enable device for providing the date, time and geographic location data.

21. The device of claim 20 wherein the processor is configured to determine the location data from any one or more of a street address, a city, a county, a zip code, a state, a country, an area code, a longitude, a latitude, an elevation, a body of water, and a landmark.

22. The device of claim 19, further comprising a smartphone having tower triangulation software contained in a phone memory configured for generating tower triangulation data, wherein the processor is configured to determine time, date, and location data from the tower triangulation data.

23. The device of claim 22 wherein the holiday mode is further configured to automatically vary an amount of illumination from a first illumination setting to a second illumination setting and at least one time at which the adjustment of the amount of illumination occurs.

24. The device of claim 22, further comprising a further user input for permitting a user to input the adjustment of the amount of illumination and a screen for displaying the time at which the adjustment of the amount of illumination occurs.

25. The device of claim 24 wherein the holiday mode is further configured to vary the amount of illumination from the first illumination setting to the second illumination setting over a pre-selected period of time.

26. The device of claim 24 wherein the holiday mode is further configured to vary the amount of illumination according to a linear function.

27. The device of claim 15, further comprising a slidable panel that exposes the first user input in a first position and that hides the first user input in a second position.

28. The device of claim 15 wherein the processor is pre-programmed to abort the holiday mode for a single Jewish event.

29. The device of claim 15, further comprising a valve apparatus that is coupled to the timer system such that the timer system, upon operation in the holiday mode, is configured to override application of voltage to the valve.
